(19) United States
(12) Patent Application Publication
(10) Pub. No.: US 2009/0106408 A1
(43) Pub. Date: Apr. 23, 2009

(54) COMMUNICATION MANAGEMENT SERVER AND COMPUTER SYSTEM

(75) Inventors: Masahiro YOSHIZAWA, Kokubunji (JP); Tatsuhiko Miyata, Inagi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/240,192

(22) Filed: Sep. 29, 2008

(30) Foreign Application Priority Data
Oct. 22, 2007 (JP) 2007-273734

(51) Int. Cl. G06F 15/16

(52) U.S. Cl. 709/223

(57) ABSTRACT

Provided is a computer system, comprising a management server and a presence server. The user terminals include a first user terminal for originating a question and a second user terminal for responding to the question originated from the first user terminal. The management server comprising: an interface coupled to the network; a processor coupled to the interface; and a memory coupled to the processor. The management server calculates an unresponsive time taken until the second user terminal becomes ready to receive a notification of the question transmitted from the first user terminal by referring the presence information acquired from the presence server upon detection of an origination of the question from the first user terminal, estimates an expected response time of the second user terminal based on the calculated unresponsive time, and notifies the first user terminal of the estimated expected response time.

### CLAIM OF PRIORITY

The present application claims priority from Japanese patent application JP2007-273734 filed on Oct. 22, 2007, the content of which is hereby incorporated by reference into this application.

### BACKGROUND OF THE INVENTION

This invention relates to a consultation intermediate system using one-to-one or one-to-many communication methods, and more particularly, to a technology for recommending an appropriate adviser.

Examples of a conventional technology for allowing a person (requester) facing a problem such as a question or a worry to find an adviser who knows better than the requester include a Q&A community and a KnowWho system.

The Q&A community, which is disclosed in, for example, JP 2001-273432 A, is implemented as a Web site on which an expert (hereinafter, referred to as “adviser”) posts an answer in response to a question posted by the requester. In general, the Q&A community has a format of a single-threaded discussion board on which a plurality of answers are posted in series in response to a single question. The requester posts a question and waits until the question is noted by an appropriate adviser and the answer is posted. Some Q&A communities provide a service of pushing to each adviser a question corresponding to a genre at which the adviser is good by mail, an instant message (IM), or the like. If the adviser immediately answers the pushed question, the requester can promptly solve the problem.

On the other hand, the KnowWho system, which is disclosed in, for example, JP 2002-312375 A, is a system for searching advisers by “what they know (who knows what)”. In the KnowWho system, at least one adviser is recommended based on a question sentence or a technical term input by the requester. In the KnowWho system, the adviser is recommended based on previously-registered profile information or the like. After viewing results of the recommendation, the requester can consult the adviser in a one-to-one manner by using phone, mail, or IM. If the adviser immediately responds to contact from the requester, the requester can promptly solve the problem.

### SUMMARY OF THE INVENTION

The consultation intermediate systems such as the Q&A community and the KnowWho system have an object to introduce an adviser who can solve a problem faced by the requester in a shorter time period than the requester.

However, the existing consultation intermediate system has a problem that a more excellent adviser receives more questions, which tends to impose more loads (in other words, which tends to make that adviser overtasked). In the existing consultation intermediate system, an excellent adviser is preferentially notified of a request for a consultation, and hence requests for a consultation tend to concentrate on a person having many fields at which he/she is good or a person having a deep knowledge in his/her specialty. As a result, the more excellent adviser, who is needed by the consultation intermediate system, may become less willing to use the system.

This demands an adviser recommendation method that can reduce the load on the excellent adviser while achieving the object of the consultation intermediate system.

The representative aspects of this invention are as follows. That is, there is provided a computer system comprising: a management server for managing communication between the user terminals; and a presence server for managing presence information on users of user terminals which is coupled with the management server. The user terminals include a first user terminal for originating a question and a second user terminal for responding to the question originated from the first user terminal. The management server comprising: an interface coupled to the network; a processor coupled to the interface; and a memory coupled to the processor. The management server calculates an unresponsive time taken until the second user terminal becomes ready to receive a notification of the question transmitted from the first user terminal by referring the presence information acquired from the presence server upon detection of an origination of the question from the first user terminal, estimates an expected response time of the second user terminal based on the calculated unresponsive time, and notifies the first user terminal of the estimated expected response time.

According to an embodiment of this invention, the consultation intermediate system presents the requester with the expected response time of each adviser to thereby allow the requester to select the adviser from a new viewpoint of the expected response time, which improves usability.

### BRIEF DESCRIPTION OF THE DRAWINGS

The present invention can be appreciated by the description which follows in conjunction with the following figures, wherein:

FIG. 1 is a configuration diagram showing a configuration of a consultation intermediate system in accordance with a first embodiment and a second embodiment of this invention;

FIG. 2 is an explanatory diagram showing a flow of a consultation in the consultation intermediate system in accordance with the first embodiment and the second embodiment of this invention;

FIG. 3 is a configuration diagram showing a configuration of a communication network in accordance with the first embodiments of this invention;

FIG. 4 is a functional block diagram showing a configuration of a consultation intermediate server in accordance with the first embodiments of this invention;

FIG. 5 is a functional block diagram showing a configuration of an IM server in accordance with the first embodiments of this invention;

FIG. 6A and FIG. 6B are sequence diagrams showing operations performed when the consultation is started in accordance with the first embodiments of this invention;

FIG. 7 is a sequence diagram showing an operation performed when a conversation is started in accordance with the first embodiments of this invention;

FIG. 8 is a sequence diagram showing an operation performed when the consultation is finished in accordance with the first embodiments of this invention;

FIG. 9 is an explanatory diagram showing an example of an input screen of the consultation client for the consultation contents in accordance with the first embodiments of this invention;

FIG. 10 is a flowchart showing a process of calculating the expected response time of a user in accordance with the first embodiments of this invention;

FIG. 11 is a flowchart of a process of calculating a load on the user in accordance with the first embodiments of this invention;

FIG. 12 is a flowchart of a process of creating the list of advisers in accordance with the first embodiments of this invention;

FIG. 13 is an explanatory diagram showing an example of a list-of-advisers screen displayed by a consultation client in accordance with the first embodiments of this invention;

FIG. 14 is an explanatory diagram showing example of a notification-of-consultation display screen displayed by an IM client in accordance with the first embodiments of this invention;

FIG. 15 is an explanatory diagram showing an example of a conversation screen displayed by the IM client in accordance with the first embodiments of this invention;

FIG. 16 is an explanatory diagram showing an example of a consultation data display screen displayed by the consultation client in accordance with the first embodiments of this invention;

FIG. 17 is an explanatory diagram showing an example of a screen for inputting the evaluation of the adviser, which is displayed by the consultation client in accordance with the first embodiments of this invention;

FIG. 18 is an explanatory diagram showing an example of the user data in accordance with the first embodiments of this invention;

FIG. 19 is an explanatory diagram showing an example of the user ability data in accordance with the first embodiments of this invention;

FIG. 20 is an explanatory diagram showing an example of the consultation data in accordance with the first embodiments of this invention;

FIG. 21 is an explanatory diagram showing an example of the conversation data in accordance with the first embodiments of this invention;

FIG. 22 is an explanatory diagram showing an example of the conversation membership data in accordance with the first embodiments of this invention;

FIG. 23 is an explanatory diagram showing an example of the consultation log in accordance with the first embodiments of this invention;

FIG. 24 is an explanatory diagram showing an example of the conversation log in accordance with the first embodiments of this invention;

FIG. 25 is an explanatory diagram showing an example of the presence information in accordance with the first embodiments of this invention;

FIG. 26 is an explanatory diagram showing an example of the presence information log in accordance with the first embodiments of this invention;

FIG. 27 is an explanatory diagram showing an example of the evaluation data in accordance with the first embodiments of this invention;

FIG. 28 is an explanatory diagram showing an example of the delayed notification data in accordance with the first embodiments of this invention;

FIG. 29 is a configuration diagram showing a configuration of a communication network in accordance with the second embodiments of this invention;

FIG. 30 is a functional block diagram showing a configuration of the consultation intermediate server in accordance with the second embodiments of this invention;

FIG. 31 is a functional block diagram showing an configuration of the multi-user chat server in accordance with the second embodiments of this invention;

FIG. 32 is a sequence diagram showing operation performed when the consultation is started in accordance with the second embodiments of this invention;

FIG. 33 is a sequence diagram showing an operation performed when the consultation is finished in accordance with the second embodiments of this invention;

FIG. 34 is an explanatory diagram showing an example of the input screen in accordance with the second embodiments of this invention; and

FIG. 35 is an explanatory diagram showing an example of a conversation screen in accordance with the second embodiments of this invention.

### DETAILED DESCRIPTION OF THE PREFERRED EMBODIMENTS

First, description will be made of an outline of an embodiment of this invention.

In a consultation intermediate system according to the embodiment of this invention, a time period (response time) necessary for each adviser to respond to a request of a question is predicted based on presence information on the adviser, tendency of past presence information, and/or, the history of past conversations.

In addition, a load imposed on each adviser is converted into a numerical value based on data related to a consultation that has currently been accepted by the adviser, data related to a consultation that was accepted by the adviser in the past, and/or data related to a request for a consultation notified in the past. In particular, an expected response time is calculated by adding the loads to thereby improve usability of the system.

The consultation intermediate system according to the embodiment of this invention presents a requester with the expected response time. In addition, the consultation intermediate system calculates the load on the adviser by conversion into a numerical value, and based on the calculated expected response time and the load converted into a numerical value, the consultation intermediate system changes the adviser to be recommended to the requester so as to obtain the maximum efficiency for the consultation intermediate system. Further, the consultation intermediate system changes the adviser to be recommended to the requester by taking into account a difficulty of a problem given by the requester and/or a deadline for solution of the problem.

According to the embodiment of this invention, the consultation intermediate system presents the requester with the expected response time of each adviser to thereby allow the requester to select the adviser from a new viewpoint of the expected response time, which improves usability. Accordingly, the adviser is selected not only from the viewpoint that an ability of the adviser is high but also from the viewpoint that the response time of the adviser is short. Therefore, the load on the adviser having a high ability is reduced. In addition, the requester can estimate a time period necessary for the solution of the problem before starting a consultation in actuality, which improves the usability of the system.

Further, based on the load converted into a numerical value, the consultation intermediate system changes a display order in a list of advisers to be recommended to the requester. Alternatively, the adviser on which a high load is imposed is excluded from the list of advisers. This reduces the requests for a consultation to be made to the adviser on which a high load is imposed, thereby reducing the load on the adviser having a high ability. In addition, the consultation intermediate system shows the expected response time obtained by adding the load converted into a numerical value, thereby making it possible to reduce the requests for a consultation to be made to the adviser having a high ability.

Further, in a case where the requester provides the difficulty of a problem and/or the deadline for the solution of the problem, the consultation intermediate system can recommend the adviser with more efficiency. For example, it is less necessary to depend on the adviser having a high ability with regard to a simple consultation and a consultation having the deadline for the solution of the problem being far off. Therefore, the consultation intermediate system recommends an ordinary adviser as much as possible with regard to the simple consultation and the consultation having the deadline being far off, the adviser having a high ability with regard to a difficult consultation, and the adviser having a short expected response time and a high ability with regard to a consultation having the early deadline. Accordingly, the consultation intermediate system can reduce the load on the adviser having a high ability.

Accordingly, the consultation intermediate system according to this embodiment can obtain the maximum answering efficiency in the entire system without impairing the usability of the system.

Hereinafter, embodiments of this invention will be described by referring to the accompanying drawings.

### First Embodiment

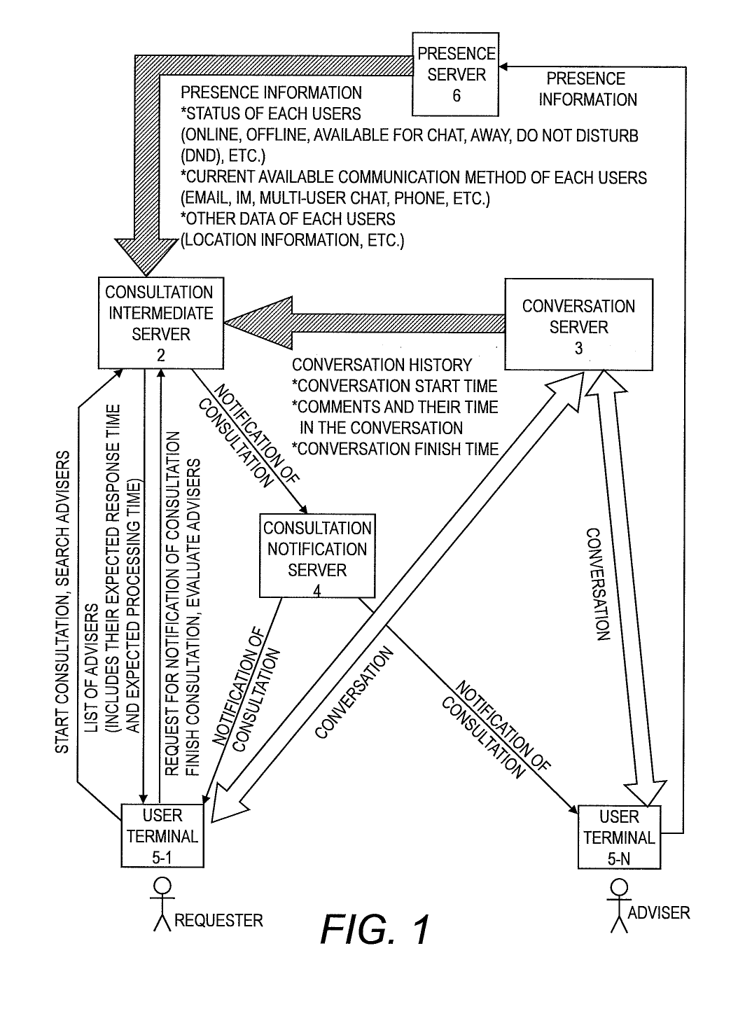

FIG. 1 is a configuration diagram showing a configuration of a consultation intermediate system according to a first embodiment and a second embodiment of this invention.

The consultation intermediate system according to the embodiment of this invention comprises a consultation intermediate server 2, a conversation server 3, a consultation notification server 4, n user terminals 5-1 to 5-n (hereinafter, also referred to simply as “user terminals 5” or collectively as “user terminal 5”), and a presence server 6.

The consultation intermediate server 2 represents a server device for receiving a consultation start from a requester, recommending an adviser suitable for each consultation, notifying the adviser of the consultation, receiving a consultation finish, receiving an evaluation of the adviser, and performing other such operation. The consultation intermediate server 2 has a function of calculating the load on each adviser based on a conversation log received from the conversation server 3, and a function of calculating the expected response time of each adviser based on the presence information received from the presence server 6.

The conversation server 3 represents a server device for providing the user terminals 5 with a communication method for conversation between users. The conversation server 3 has a function of providing existing conversation means (including mail, IM, phone, discussion board, Q&A community, multi-user chat, and video conferencing), and a function of transmitting the conversation log of the conversation between the users to the consultation intermediate server 2. The single consultation intermediate system may include conversation servers 3 for providing a plurality of types of conversation means. In addition, the conversation server 3 may have a function of relaying conversation data (text and voice) in order to maintain the conversation log with accuracy.

The conversation log represents data including a conversation start time of a conversation between the requester and the adviser, a comment date and comment contents of a comment made by the requester or the adviser, and a conversation finish time of a conversation between the requester and the adviser. Some communication methods provided by the conversation server 3 cannot explicitly acquire the conversation start time and/or the conversation finish time. In such a case, the consultation intermediate server 2 may estimate the conversation start time and/or the conversation finish time based on the comment date and the comment contents.

The consultation notification server 4 represents a server device for providing the consultation intermediate server 2 with the communication method for distributing a notification of a consultation to the user terminals 5. The consultation notification server 4 provides existing data pushing means (including mail, IM, phone, multi-user chat, and video conferencing).

Unlike the conversation server 3, the consultation notification server 4 does not need to be provided with a function specific to this invention. The single consultation intermediate system may include consultation notification servers 4 for providing a plurality of types of communication method. Further, a single server (for example, enhanced IM server) may have both the function of the conversation server 3 and the function of the consultation notification server 4.

The user terminals 5 each represent a device such as a personal computer (PC) or a mobile terminal (for example, cellular phone), which is used by the user of the consultation intermediate system. Each user of the consultation intermediate system uses at least one user terminal. In the consultation intermediate system, the requester and the adviser can use the user terminals having the same function. In other words, one user can use the same user terminal both to start a new consultation and to answer a consultation requested by someone.

A plurality of programs run on the user terminal 5. The plurality of programs include a consultation client for connection to the consultation intermediate server 2, a conversation client for connection to the conversation server 3, a consultation notification client for receiving the notification of the consultation from the consultation notification server 4, and a presence client for connection to the presence server 6. Depending on the configuration of the system, the conversation client may also have the function of the consultation notification client. For example, in a case where the enhanced IM server serves as the conversation server 3 and the consultation notification server 4, an IM client functions as the conversation client and the consultation notification client.

The presence server 6 represents a server device for managing the presence information on each user. The presence server 6 collects the presence information from the presence client running on each of the user terminals 5. In addition, the presence server 6 needs to have a function of transmitting the presence information to the consultation intermediate server 2. The presence server generally has a function of providing the presence information to another communication device, which eliminates the need to provide a specific function in this embodiment.

The presence information is a generic term for data representing a current status of each user. The presence information includes a status of each user, a communication method that can be currently used by each user, and other data. The status of a user is data representing “online”, “offline”, “free to chat”, “away”, “do not disturb”, and the like. The communication method that can be used by a user is data representing a type of communication method such as “mail”, “IM”, “multi-user chat”, or “phone” and an identifier (for example, mail address if communication method is mail) for communication with the user. The other data includes location information on a user.

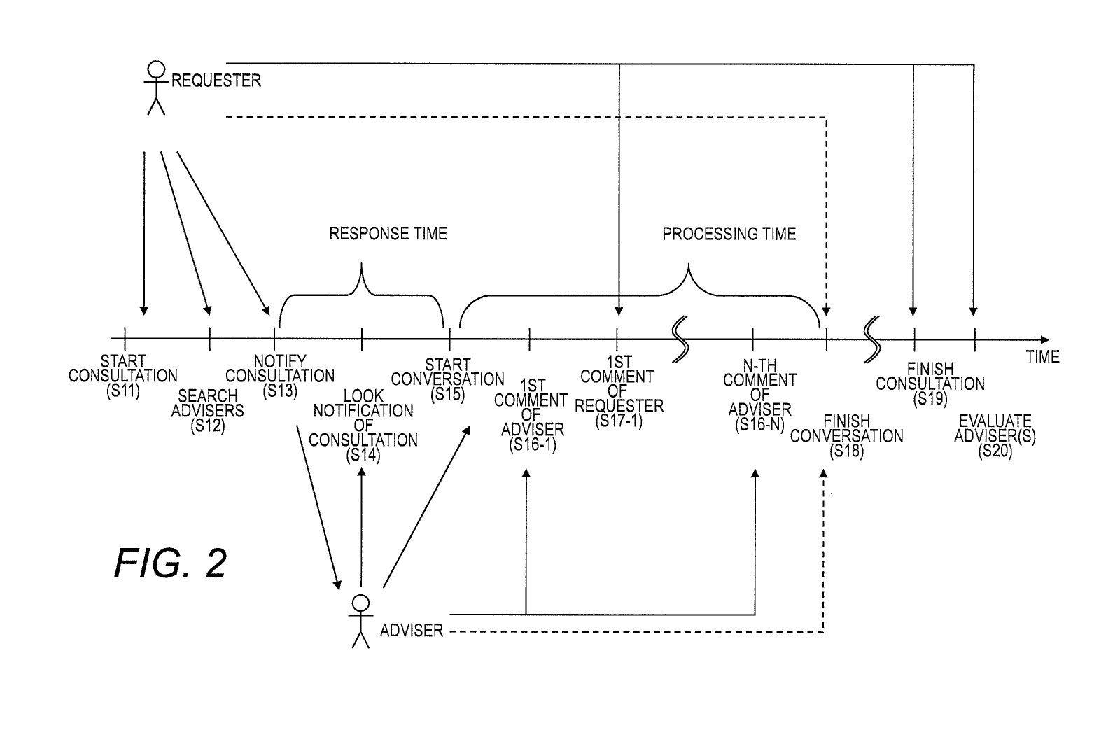

FIG. 2 is an explanatory diagram showing a flow of a consultation in the consultation intermediate system according to the first embodiment and the second embodiment of this invention.

First, the requester starts a consultation in the consultation intermediate system (S11). Subsequently, the advisers are searched for ones that may solve the consultation (S12), and a message for notifying of consultation contents (hereinafter, referred to as “notification of consultation”) is transmitted to one or more advisers included in a search result (S13).

The adviser views the notification of the consultation through some communication method such as mail (S14). If the consultation contents lead to a judgment that the adviser may be able to answer the consultation, the adviser starts a conversation with the requester (S15).

After that, the comment is repeatedly exchanged between the adviser and the requester (S16 and S17). When the adviser solves the problem, or when it turns out to be difficult for the adviser to solve the problem, one of the requester and the adviser finishes the conversation (S18).

If the problem is not solved, the procedure of Steps S12 to S18 is repeated to consult another adviser. When any of the advisers solves the problem, or when the requester gives up the solution of the problem, the requester finishes the consultation (S19).

After finishing the consultation, the requester evaluates the adviser (S20).

In this embodiment, a time period taken from the transmission of the notification of the consultation to the adviser (S13) to the conversation start with respect to the adviser (S15) is referred to as response time of the adviser. In addition, a time period taken from the conversation start with respect to the adviser (S15) to the conversation finish (S18) is referred to as processing time of the adviser. Depending on the communication method used for the conversation, a method of calculating the response time and the processing time may be changed. For example, when the communication method used for the conversation is mail, the first commenting (first mail transmission) from the adviser is performed without a procedure for starting the conversation. In that case, a time of the first comment of the adviser (S16-1) may be handled as the conversation start time (S15).

Hereinafter, the first embodiment will be described by taking the consultation intermediate system that uses a one-to-one communication method as an example.

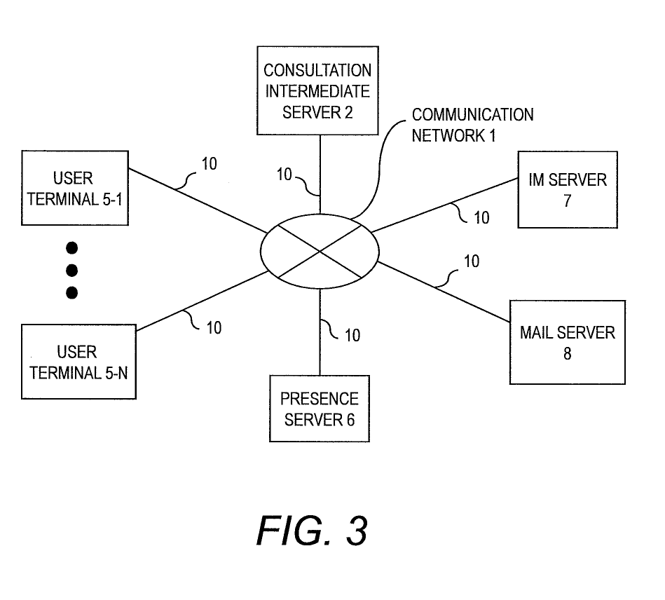

FIG. 3 is a configuration diagram showing a configuration of a communication network according to the first embodiment of this invention.

The consultation intermediate server 2, an instant messaging server 7 (IM server 7), a mail server 8, the presence server 6, and the n user terminals 5-1 to 5-n are coupled to one another via physical communication lines 10 and a communication network 1.

In this embodiment, instant messaging (IM) is used for the conversation between the users, and IM and electronic mail are used for the notification of the consultation. Therefore, in this embodiment, the IM server 7 is operated as the conversation server 3 and the consultation notification server 4. In addition, the mail server 8 is operated as a second consultation notification server 4. In a similar manner, on each of the user terminals 5, an IM client runs as the conversation client and the consultation notification client, and a mail client runs as a spare consultation notification client. Further, among users having two or more user terminals, there may be a user having the user terminal (for example, cellular phone) on which only the mail client runs.

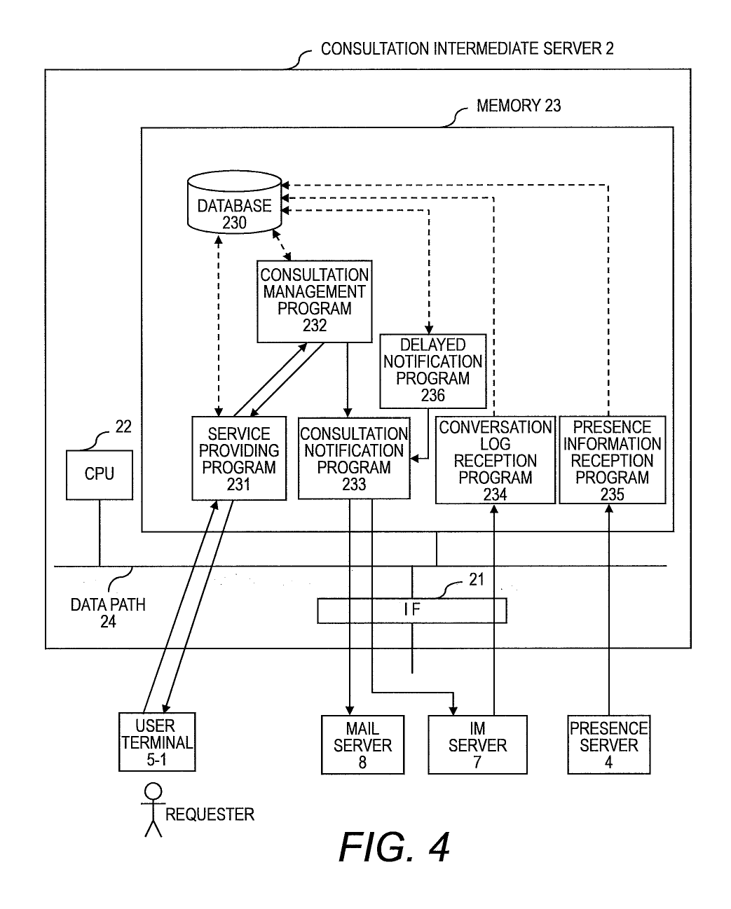

FIG. 4 is a functional block diagram showing a configuration of the consultation intermediate server 2 according to the first embodiment of this invention.

The consultation intermediate server 2 includes an IF 21, a CPU 22, and a memory 23, and the IF 21, the CPU 22, and the memory 23 are coupled to one another via a data path 24.

The consultation intermediate server 2 transmits/receives a packet via the IF 21. Each of the programs executed on the consultation intermediate server 2 is stored in the memory 23. At an operation of the consultation intermediate server 2, the CPU 22 reads and executes the programs stored in the memory 23 via the data path 24. The arrows within the figure indicate flows of data among the programs. Of those, the dotted arrows within the figure indicate database operations.

A database 230, a service providing program 231, a consultation management program 232, a consultation notification program 233, a conversation log reception program 234, a presence information reception program 235, and a delayed notification program 236 are stored in the memory 23.

The database 230 holds data necessary for the operation of the consultation intermediate server 2. The data held in the database 230 includes user data 1000, user ability data 1100, consultation data 1200, conversation data 1300, conversation membership data 1400, a consultation log 1500, a conversation log 1600, presence information 1700, a presence information log 1800, evaluation data 1900, and delayed notification data 2000. In this embodiment, those items of data are all held in a table format.

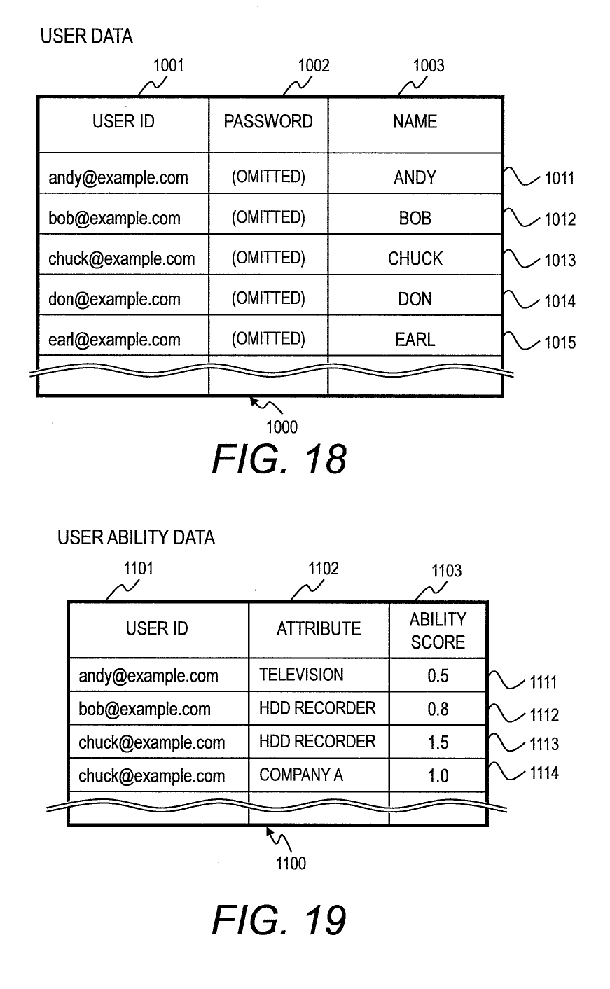

FIG. 18 shows an example of the user data 1000.

The user data 1000 represents basic data on users which is necessary for management of the users. Each of the users of the consultation intermediate system necessarily has one item of user data. The user data 1000 is previously registered by an administrator of the consultation intermediate system or the users themselves.

A user ID for uniquely identifying a user across the consultation intermediate system is held in a column 1001. In this embodiment, the user ID represents a character string conforming to the same format as an email address. A password necessary for coupling the consultation client to the consultation intermediate server 2 is held in a column 1002. A name of the user is held in a column 1003. The name is used for the consultation client and the conversation client (which include IM client, mail client, and chat client).

FIG. 19 shows an example of the user ability data 1100.

Data indicating a field at which each user is good and his/her specialty is held as the user ability data 1100. Each of the users of the consultation intermediate system has none of or one or more items of user ability data. The data item is previously registered by the administrator or the user. Alternatively, the consultation intermediate server 2 may create the item of the user ability data 1100 based on a history of consultations. Further, item of the user ability data 1100 may be created by combining the above-mentioned two methods.

The user ID for uniquely identifying a user across the consultation intermediate system is held in a column 1101. A name of an attribute is held in a column 1102. A numerical value (ability score) representing a level of an ability of the user is held in a column 1103.

In this embodiment, the level of the ability regarding the attribute is represented by the numerical value. The ability score is set in such a manner that as the ability to answer a question regarding the attribute is higher, the ability score becomes larger.

Further, an evaluation regarding an attribute that is not included in a corresponding row of the user ability data 1100 is set to 0 (fair). For example, a row 1111 indicates that a user (whose name is Andy) with the user ID “andy@example.com” has the attribute “television”, and that the ability score regarding the attribute is “0.5”. However, Andy does not have the attribute “HDD recorder” in the row 1111 of the user ability data 1100, the ability score of Andy regarding the attribute “HDD recorder” is 0.

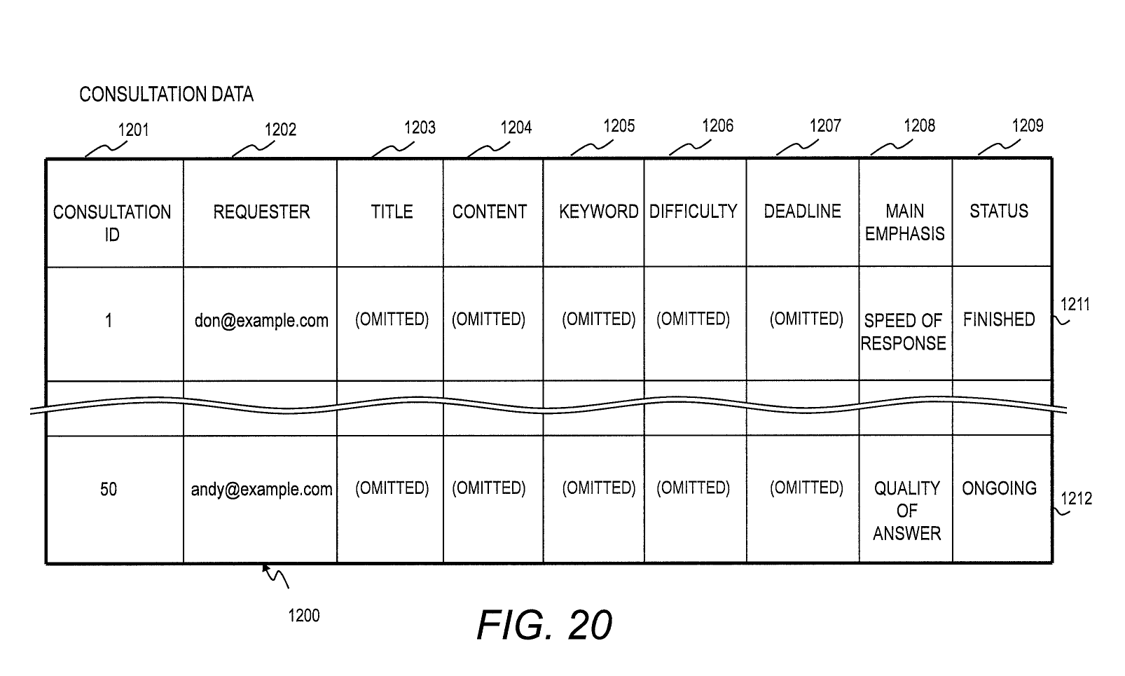

FIG. 20 shows an example of the consultation data 1200.

The consultation data 1200 represents basic data on consultations that have been handled by the consultation intermediate server 2. At a start of a consultation, the consultation intermediate server 2 creates one item of consultation data per consultation.

A consultation ID for uniquely identifying a consultation across the consultation intermediate system is held in a column 1201. In this embodiment, as the consultation ID, the consultation intermediate server 2 assigns a unique integer to each consultation. The user ID of the requester who has started the consultation is held in a column 1202. A title of the consultation is held in a column 1203. Contents of the consultation are held in a column 1204. A keyword indicating a characteristic of the consultation is held in a column 1205. A difficulty of the consultation is held in a column 1206. A deadline by which the consultation is to be solved is held in a column 1207. A main emphasis to be put on the recommendation of advisers is held in a column 1208. A status of the consultation is held in a column 1209. The status of the consultation is one of “ongoing”, “unrated”, and “finished”.

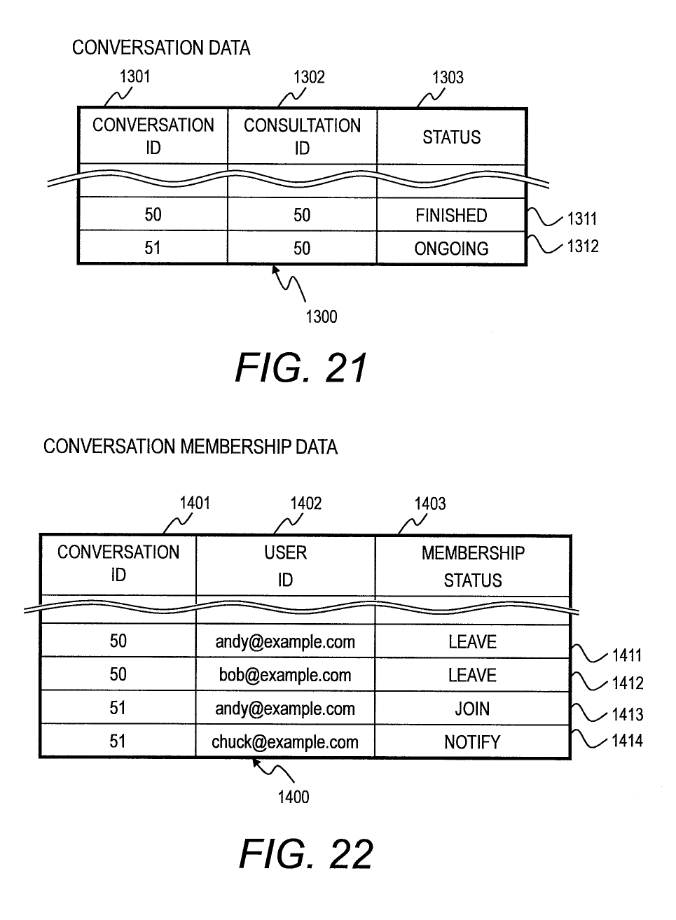

FIG. 21 shows an example of the conversation data 1300.

The conversation data 1300 represents basic data on conversations that have been set by the consultation intermediate server 2. Upon setting of a conversation, the consultation intermediate server 2 creates one item of conversation data per conversation.

A conversation ID for uniquely identifying a conversation across the consultation intermediate system is held in a column 1301. In this embodiment, as the conversation ID, the consultation intermediate server 2 assigns a unique integer to each conversation. The consultation ID of a consultation related to the conversation is held in a column 1302. In this embodiment, a plurality of conversations (for example, IM communications with a plurality of advisers) are performed per consultation, and hence none of or one or more items of conversation data are created per consultation ID. A status of the conversation is held in a column 1303. The status of the conversation is one of “ongoing” and “finished”.

FIG. 22 shows an example of the conversation membership data 1400.

The conversation membership data 1400 is data indicating a membership status in the conversation of each user, which is set by the consultation intermediate server 2. The consultation intermediate server 2 creates items of conversation membership data for the number of combinations of a conversation and the user notified of the conversation.

The conversation ID of a conversation is held in a column 1401. The user ID of a user (requester or adviser) notified of the conversation is held in a column 1402. The membership status in the conversation of the user is held in a column 1403. The membership status in the conversation is one of “notify”, “join” and “leave”. In a case where the user has not yet participated in the conversation even once since the user is notified of the conversation, the membership status is set to “notify”. While the user is participating in the conversation, the membership status is set to “join”. After the user finishes the conversation, the membership status is set to “leave”.

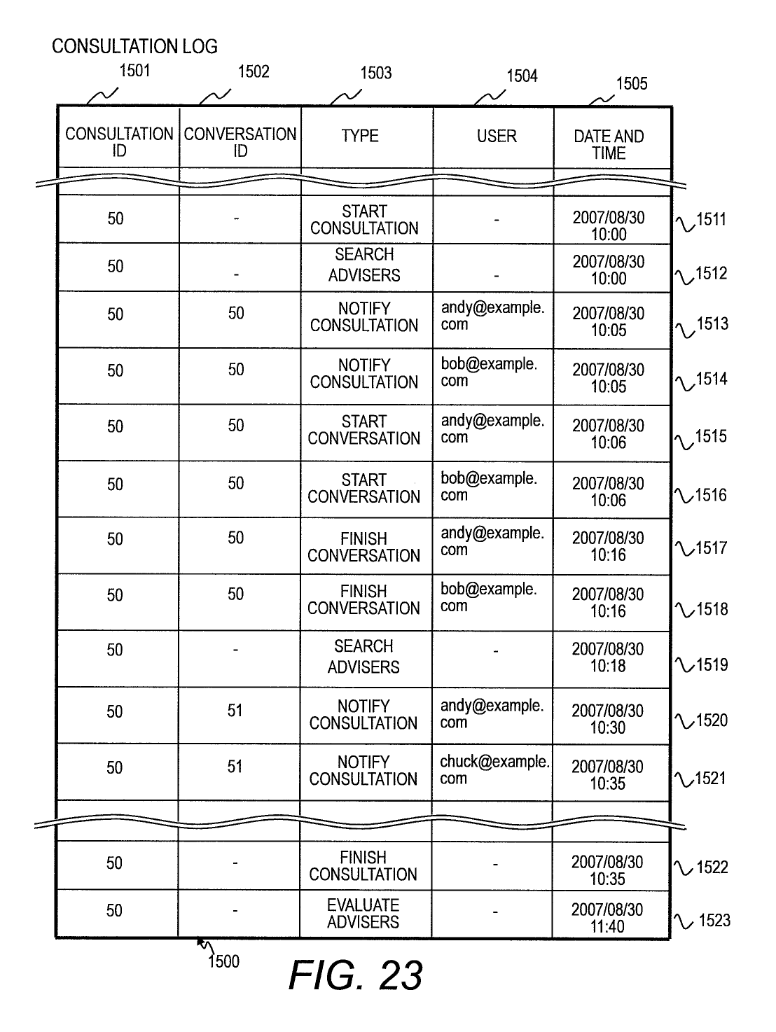

FIG. 23 shows an example of the consultation log 1500.

The consultation log 1500 is data indicating a progress of a consultation handled by the consultation intermediate server 2. The consultation intermediate server 2 creates a consultation log having a plurality of entries per consultation. The consultation log is used later for calculating the response time and the processing time.

The consultation ID and the conversation ID are held in columns 1501 and 1502, respectively. A type of log entry is held in a column 1503. The user ID of the user related to the log is held in a column 1504. A date and time at which a log entry is created is held in a column 1505. For example, a row 1514 indicates that Bob (bob@example.com) is notified of the conversation (with conversation ID “50”) regarding the consultation with the consultation ID “50” at 10:05 on Aug. 30, 2007.

As the conversation ID in the column 1502, only for a log entry regarding a conversation (“notify consultation”, “start conversation”, or “finish conversation”), the conversation ID of the conversation is set. The type in the column 1503 is one of “start consultation” for indicating the date and time of the consultation start, “search advisers” for indicating the date and time at which an adviser search is performed, “notify consultation” for indicating the date and time at which the notification of the consultation is transmitted, “start conversation” for indicating the date and time at which the conversation is started, “finish conversation” for indicating the date and time at which the conversation is finished, “finish consultation” for indicating the date and time of the consultation finish, and “evaluate advisers” for indicating the date and time at which the adviser is evaluated.

In a case where the type in the column 1503 is “notify consultation”, the user ID of the user to be notified is stored in the column 1504. In a case where the type is “start conversation” or “finish conversation”, the user ID of the user who starts or finishes the conversation, respectively, is included in the column 1504.

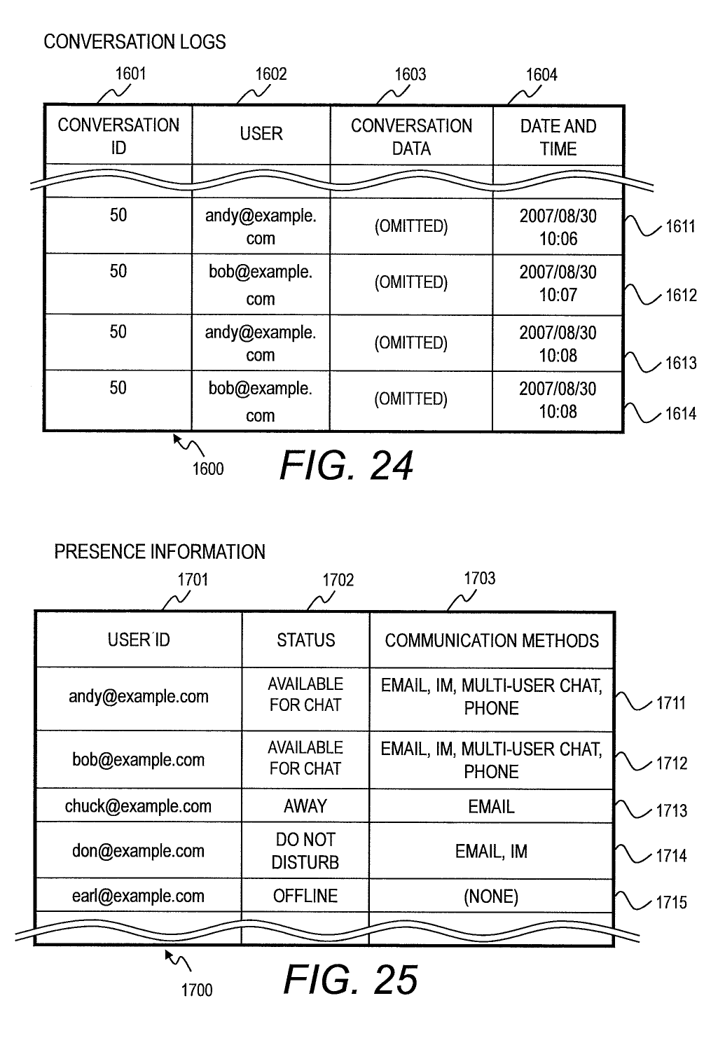

FIG. 24 shows an example of the conversation log 1600.

The conversation log 1600 is data indicating items of conversation data which have been exchanged between the requester and the adviser so far. The consultation intermediate server 2 creates a conversation log having none of or one or more entries per conversation. The conversation log is used later for calculating the load on the user.

The conversation ID of a conversation is held in a column 1601. The user ID of the user who transmits conversation data of the conversation is held in a column 1602. The transmitted conversation data is held in a column 1603. A transmission date and time of the conversation data is held in a column 1604. In this embodiment, IM is used for the conversation, and hence the conversation data is text data. However, in a case where the phone is used for the conversation, voice data may be stored as the conversation data. In addition, in a case where video is used for the conversation, video and voice data are stored as the conversation data.

FIG. 25 shows an example of the presence information 1700.

The presence information 1700 is data indicating current presence information on each user. The consultation intermediate server 2 acquires the presence information from the presence server 6. The consultation intermediate server 2 holds one item of presence information per user.

The user ID of a user is held in a column 1701. A status of the user is held in a column 1702. The communication method that can be currently used by the user is held in a column 1703. In a case where other data is included in the presence information acquired from the presence server 6, another row may be added to the presence information 1700 to store the data therein.

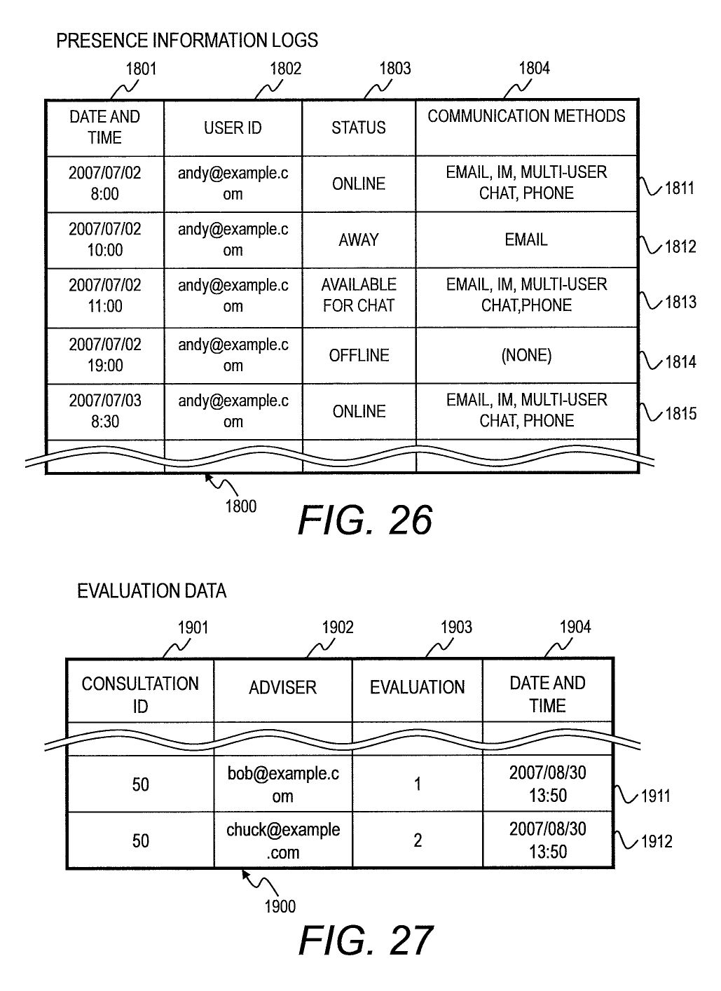

FIG. 26 shows an example of the presence information log 1800.

The presence information log 1800 is data indicating past presence information on each user. The consultation intermediate server 2 creates a presence information log per user, and creates one entry of the presence information log each time there is a change in presence information on each user. By using the presence information log 1800, the consultation intermediate server 2 can increase precision of the expected response time of each user.

A date and time at which the presence information is acquired is held in a column 1801. The user ID is held in a column 1802. The current status of the user is held in a column 1803. Communication methods available to the user at the time are held in a column 1804.

FIG. 27 shows an example of the evaluation data 1900.

The evaluation data 1900 is data indicating an evaluation given to the adviser by the requester regarding the past consultation.

The consultation ID of the consultation regarding which the evaluation has been given is held in a column 1901. The user ID of the adviser is held in a column 1902. The evaluation given to the adviser by the requester is held in a column 1903. The date and time at which the evaluation is given is held in a column 1904.

In this embodiment, the requester gives the adviser a value ranging from “−2” to “+2” in such a manner that the larger value indicates the higher evaluation. To be specific, the value “−2” corresponds to “very bad”, “−1” to “bad”, “0” to “fair”, “1” to “good”, and “2”to “very good”. For example, a row 1911 indicates that the evaluation “1” (good) is given to an adviser (whose name is Bob) with the user ID “bob @example.com” regarding the consultation with the consultation ID “50”.

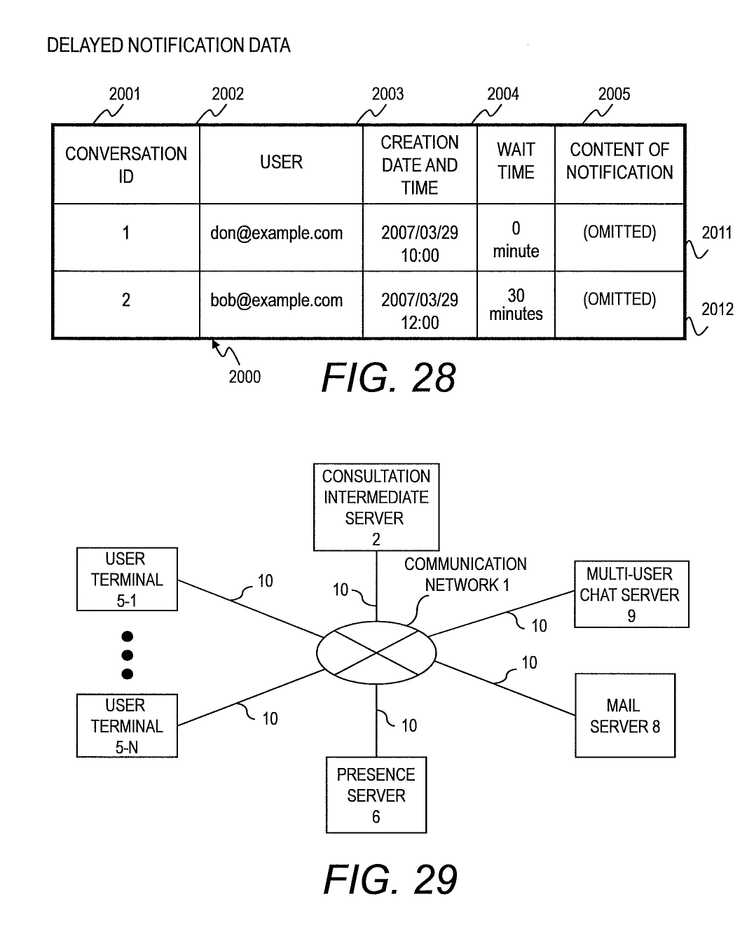

FIG. 28 shows an example of the delayed notification data 2000.

The delayed notification data 2000 is data indicating contents of the notification of the consultation the transmission of which is to be delayed and a length of a wait time for the notification of the consultation. In a case where the transmission of the notification of the consultation is to be delayed for some reason, the consultation intermediate server 2 creates one item of delayed notification data per notification of the consultation. Then, the delayed notification program 236, which will be described later, transmits the notification of the consultation based on the delayed notification data 2000.

The conversation ID is held in a column 2001. The user ID of the user to whom the notification of the consultation is to be transmitted is held in a column 2002. A creation date and time of the notification of the consultation is held in a column 2003. The wait time is held in a column 2004. The contents of the notification of the consultation are held in a column 2005.

The service providing program 231 is a program for performing transmission/reception of data to/from the consultation clients running on the user terminals 5. The service providing program 231 transfers all of the data received from the consultation clients to the consultation management program 232. Further, the service providing program 231 transfers data received from the consultation management program 232 to any one of the consultation clients based on the user ID included in the data.

In addition, before receiving the first item of data from the consultation client, the service providing program 231 always performs user authentication for the consultation client. To be specific, the service providing program 231 compares a combination of the user ID and the password given by the consultation client with the data stored in the user data 1000. If there is a match, it is judged that the user authentication is successful. In the following description, the user authentication for the consultation client is assumed to have been performed in advance.

The consultation management program 232 is a program for performing start and finish processings for a consultation and a recommendation of advisers in response to a request from the consultation client. In addition, the consultation management program 232 transmits the notification of the consultation to the adviser through the consultation notification program 233.

The consultation notification program 233 is a program for transmitting the notification of the consultation through the consultation notification server 4 (in this embodiment, IM server 7 and mail server 8). Accounts used for the transmission of the notification of a consultation are previously set in the IM server 7 and the mail server 8. For those accounts, a user name and a password for connection to a simple mail transfer protocol (SMTP) server may be used. The consultation notification program 233 transmits the notification of the consultation through those accounts.

The conversation log reception program 234 is a program for receiving a conversation log transmitted from the conversation server 3 (in this embodiment, IM server 7) and holding the conversation log in the database 230. The conversation log reception program 234 operates the conversation data 1300, the conversation membership data 1400, the consultation log 1500, and the conversation log 1600.

The method of receiving the conversation log may be any one of pushing and pulling. The pushing is a method in which the conversation server 3 creates a log entry and at the same time transmits the log to the conversation log reception program 234. By using the pushing, the latest conversation log can be immediately reflected on the operation of the consultation intermediate server 2. On the other hand, the pulling is a method in which the consultation intermediate server 2 requests the conversation server 3 to periodically transmit the conversation log. By using the pulling, a time period during which the load on the consultation intermediate server 2 is low can be selected to process the conversation log.

In this embodiment, the immediate reflecting of the conversation log on the operation of the consultation intermediate server 2 is given a higher priority by using the pushing.

The presence information reception program 235 is a program for receiving presence information from the presence server 6 and holding the presence information in the database 230. The presence information reception program 235 operates the presence information 1700 and the presence information log 1800.

The method of receiving the presence information may be any one of the pushing and the pulling. The pushing is a method in which, if there is a change in presence information, the presence server 6 can immediately transmit the change to the presence information reception program 235. The presence server 6 generally provides the pushing based on a SUBSCRIBE/NOTIFY mechanism. By using the pushing, the latest presence information can be immediately reflected on the operation of the consultation intermediate server 2. On the other hand, the pulling is a method in which the consultation intermediate server 2 requests the presence server 6 to periodically transmit the presence information. By using the pulling, the time period during which the load on the consultation intermediate server 2 is low can be selected to process the presence information.

In this embodiment, the immediate reflecting of the presence information on the operation of the consultation intermediate server 2 is given a higher priority by using the pushing.

The delayed notification program 236 is a program for transmitting the notification of a consultation based on the delayed notification data 2000. For example, the consultation management program 232 registers the delayed notification data in the database in such cases as described below:

(1) a case where, when the requester tries to transmit the notification of the consultation, the presence information indicates that the adviser is in such a status as not to be able to receive the notification of the consultation (the wait time is set to “0”); and

(2) a case where, when the requester tries to transmit the notification of the consultation, the load on the adviser is high (the wait time is set to a value corresponding to the load).

The delayed notification program 236 is activated periodically (for example, periodically at short intervals) and/or when a new item of presence information is registered. The activated delayed notification program 236 performs the following processing on all of items of delayed notification data.

First, the delayed notification program 236 examines whether or not a time obtained by adding the wait time 2004 to the creation date and time 2003 is earlier than the present time. If the time obtained by the addition has already been the past, the wait time is judged to have ended. If the wait time has ended, based on the presence information 1700, the user 2002 examines whether or not the notification of the consultation can be received. If the user 2002 can receive the notification of the consultation, the delayed notification program 236 transmits the notification of the consultation to the user 2002 through the consultation notification program 233, and deletes the delayed notification data related to the notification of the consultation from the database.

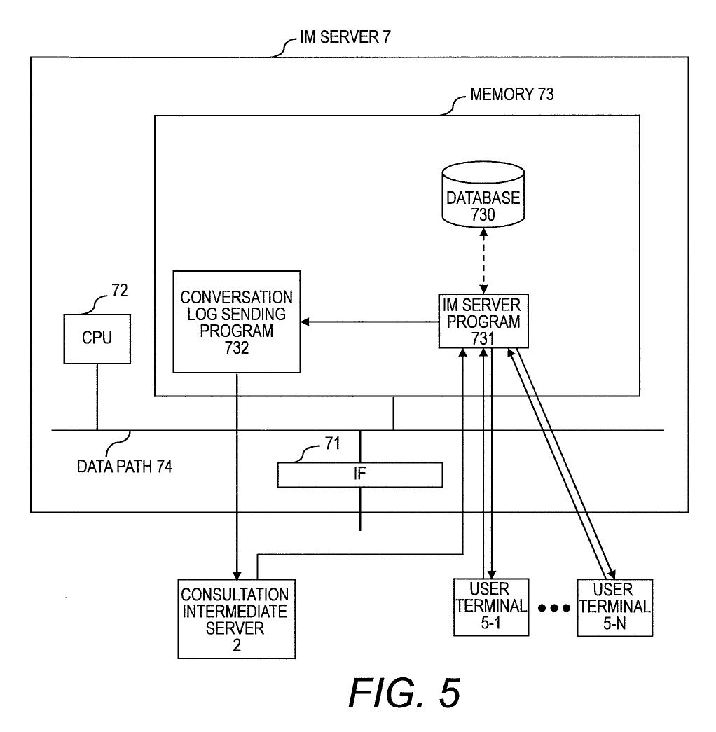

FIG. 5 is a functional block diagram showing a configuration of the IM server 7 according to the first embodiment of this invention.

The IM server 7 includes an IF 71, a CPU 72, and a memory 73, and the IF 71, the CPU 72, and the memory 73 are coupled to one another via a data path 74.

The IM server 7 transmits/receives a packet via the IF 71. Each of the programs executed on the IM server 7 is stored in the memory 73. At an operation of the IM server 7, the CPU 72 reads and executes the programs stored in the memory 73 via the data path 74. The arrows within the figure indicate flows of data among the programs. Of those, the dotted arrows within the figure indicate database operations.

A database 730, an IM server program 731, and a conversation log sending program 732 are stored in the memory 73.

The database 730 holds data necessary to run the IM server program 731. Account information on the IM server and the like are used as the data, but it is not necessary to store data specific to this embodiment, and hence, in this embodiment, detailed description of a structure of the data will be omitted.

The IM server program 731 is a program for performing transmission/reception of the conversation data to/from the IM client running on each user terminal 5. Based on the user ID included in the conversation data, the IM server program 731 forwards the conversation data transmitted from one IM client to another IM client. The forwarding is a general operation of the IM server.

The conversation log sending program 732 is a program for transmitting the conversation log to the consultation intermediate server 2. As an operation specific to this embodiment, before transferring the conversation data, the IM server program 731 shapes the contents into a form of a conversation log, and transmits the conversation log to the conversation log sending program 732.

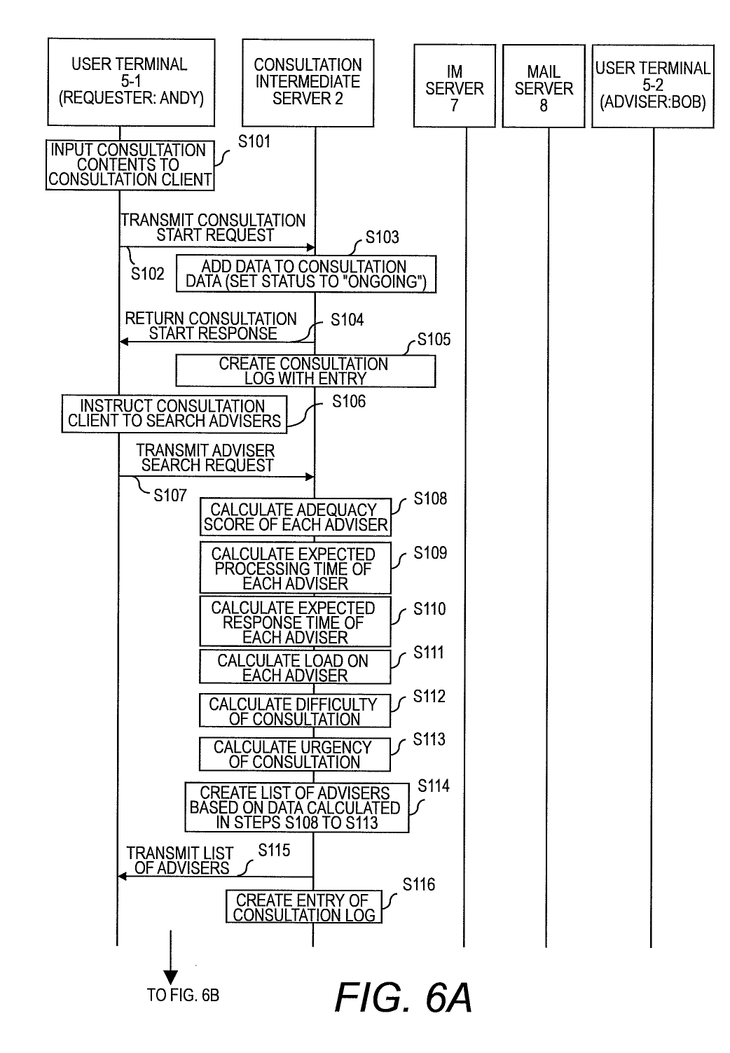

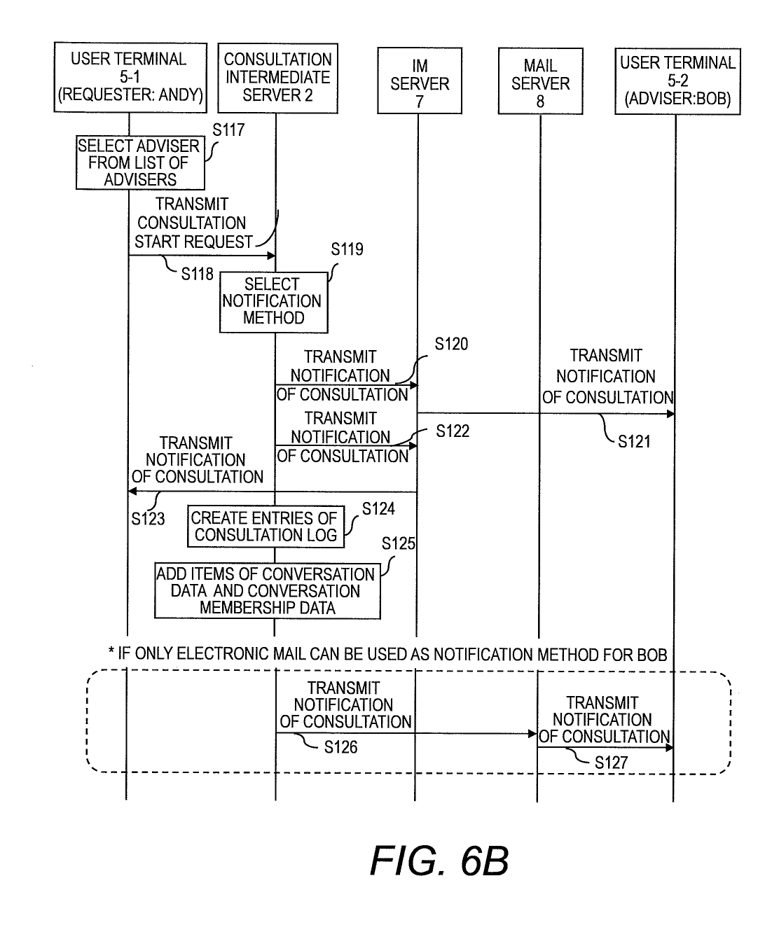

FIGS. 6A, 6B, 7, and 8 are sequence diagrams showing examples of operations performed from the start of a consultation to the finish thereof. In this example, description will be made of a case where the requester (Andy) who has the user ID “andy@example.com” and uses the user terminal 5-1 starts the consultation.

FIGS. 6A and 6B are sequence diagrams showing an example of the operation performed after the requester starts the consultation until the requester transmits the notification of the consultation to the adviser.

First, the requester inputs the consultation contents to the consultation client running on the user terminal 5-1 (S101). The consultation contents need to include data for conveying the consultation contents to the adviser and data used by the consultation intermediate server to recommend advisers.

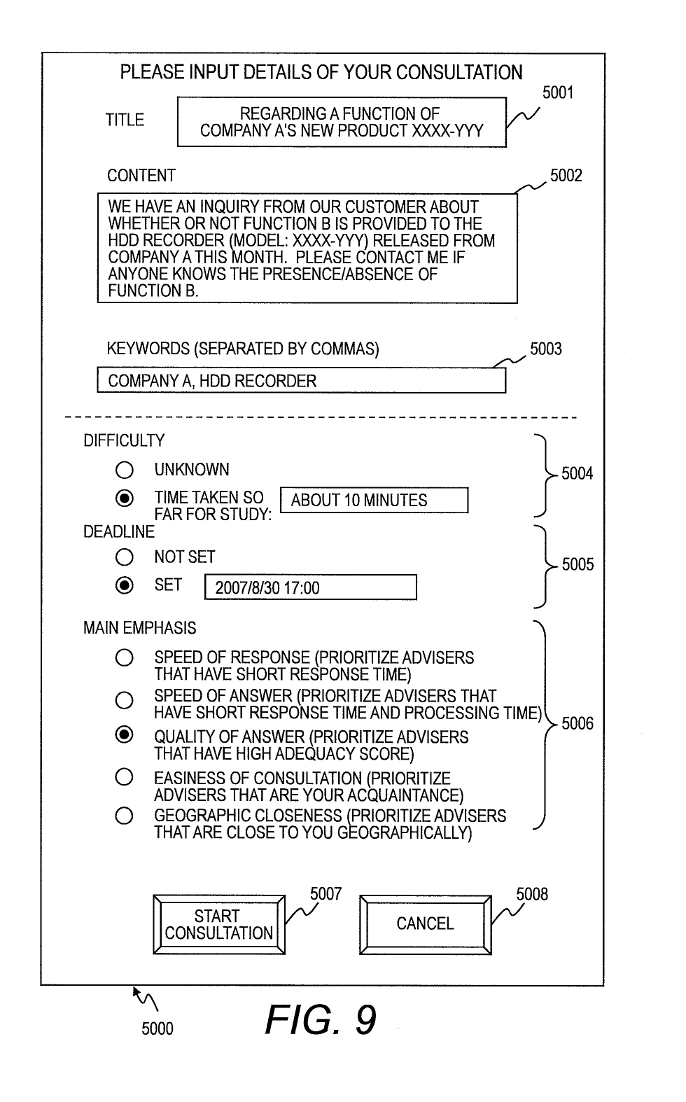

FIG. 9 shows an example of an input screen 5000 of the consultation client for the consultation contents.

The input screen 5000 for the consultation contents shown in FIG. 9 includes input fields for a title 5001 of a consultation, contents 5002 of the consultation, keywords 5003 indicating characteristics of the consultation, a difficulty 5004 of the consultation, a deadline 5005 for solution of the consultation, and a main emphasis 5006 put by the requester. In addition, the input screen 5000 includes a consultation start button 5007 and a cancel button 5008.

The title 5001 and the contents 5002 are essential data for conveying the consultation contents to the adviser. It should be noted that, if the consultation contents are quite understandable, only the contents 5002 of the consultation suffice. In addition, the consultation contents may be notified as voice or video data recorded by the consultation client.

The keywords 5003 are essential data for indicating the attributes of the consultation. However, without providing the input field for the keywords, the keywords may be automatically generated by analyzing the attributes of the consultation from the title 5001 and/or the contents 5002 of the consultation.

The difficulty 5004 is an optional item of data. If the requester specifies the difficulty, a value thereof is used as an initial value of the difficulty. As a specification method for the difficulty, the requester inputs some numerical value. However, it is difficult to objectively convert the difficulty of a matter at which the requester is weak into a numerical value. Therefore, as a simple input method, the difficulty may be calculated from a length of a time period obtained by having the requester input a time period that has been taken so far for studying the problem.

The deadline 5005 is an optional item of data. If the requester specifies the deadline, a value thereof is used as an initial value of the deadline. It should be noted that, if the requester does not specify the deadline, the consultation intermediate server may judge that there is no deadline, or may set the deadline to a preset initial value (for example, 1 day) common across the system. To prevent one consultation from being left unsolved without an end, it is necessary to preset the initial value common across the system.

The main emphasis 5006 is an optional item of data. The main emphasis 5006 is referenced when the consultation intermediate server 2 ranks advisers for recommending a suitable adviser. If the requester does not specify the main emphasis, the main emphasis may be set to a preset initial value (for example, speed of response) common across the system.

In this embodiment, the consultation client is set as an original client running on the user terminal 5. However, the consultation client may be a Web application running on the consultation intermediate server 2. If the user terminal 5 is provided with a Web browser, there is no need to install the original client on the user terminal 5.

Subsequently, the consultation client on the user terminal 5-1 transmits a consultation start request to the consultation intermediate server 2 (S102). The consultation start request includes the value input by the requester in Step S101.

When the consultation management program 232 on the consultation intermediate server 2 receives the consultation start request, the consultation management program 232 stores data included in the consultation start request as an item of the consultation data 1200 (S103). At this time, the status of the consultation to be stored is set to “ongoing”. In this embodiment, the consultation ID of the consultation (requester of which is Andy) is “50”.

After storing the item of the consultation data 1200, the consultation management program 232 returns a consultation start response to the consultation client of the user terminal 5-1 through the service providing program 231 (S104). The consultation start response includes the consultation ID assigned to the consultation. The consultation client uses the consultation ID for the subsequent processings to request the consultation management program 232 to perform the adviser search, the consultation finish, and other such processing. After finishing the transmission of the consultation start response, the consultation management program 232 creates a consultation log having an entry with the type “start consultation” (S105).

Subsequently, the requester instructs the consultation client to search advisers (S106). The consultation client transmits an adviser search request including the consultation ID to the consultation management program 232 (S107). It should be noted that, in this embodiment, the consultation start request and the adviser search request are separately transmitted, but the first adviser search may be performed at the same time as the reception of the consultation start request. In that case, the number of operations performed by the requester can be reduced.

When the consultation management program 232 receives the adviser search request, the consultation management program 232 calculates the following data items necessary to create a list of advisers suitable to the consultation (hereinafter, referred to as “list of advisers”) (S108 to S113).

(1) an adequacy of each user regarding the consultation

(2) an expected processing time of each user regarding the consultation

(3) the expected response time of each user regarding the consultation

(4) the load on each user at the present time

(5) the difficulty of the consultation

(6) an urgency of the consultation

(7) a similarity of the adequacy between users

In this embodiment, a combination of one or more items of those calculated data is necessary. Not all of the data items are essential, but more data items allow more efficient recommendation of advisers.

To be specific, first, the consultation management program 232 calculates a numerical value (hereinafter, referred to as “adequacy score”) representing the adequacy of each user regarding the consultation from the characteristics of the consultation and the ability of each user (S108).

An example of a method of calculating the adequacy score will be shown. In this embodiment, as the characteristics of the consultation, the keywords input by the requester are used. The value of the user ability data 1100 is used as the ability of each user. In this embodiment, the keywords are compared with the attributes 1102 of the user ability data 1100 to judge whether or not there is a match, and if there is a match, the ability score 1103 of the user ability data 1100 is added to the adequacy score of the user.

For example, by referring to the user ability data 1100 (FIG. 19), the ability score of the user (Bob) with the user ID “bob@example.com” regarding the consultation for which the keywords “HDD recorder” and “Company A” are specified is obtained as “0.8” as shown on a row 1112. In a similar manner, by referring to the user ability data 1100 (FIG. 19), the ability score of a user (whose name is Chuck) with the user ID “chuck@example.com” is obtained as “2.5” by adding values in rows 1113 and 1114.

Subsequently, the consultation management program 232 calculates an expected processing time of each user regarding the consultation (S109). An example of a method of calculating an expected processing time of each user will be shown. The expected processing time is calculated by one item of or a combination of two or more items of the following:

(1) adding a fixed value set to all users in common;

(2) adding a fixed value set to each user separately;

(3) adding an average value of the past processing times of each user;

(4) adding an average value of the past processing times of each user regarding consultations similar to the current consultation; and

(5) adding a value calculated based on the adequacy score of each user regarding the current consultation.

The past processing times can be used for the calculation of the expected processing time. This is because a time period taken by a given user to answer a consultation can be expected to be constant to some extent even if there are individual differences between the processing times of users (the above-mentioned item (3)). In addition, the characteristics of the consultation may be taken into account based on the assumption that the time period taken to answer a consultation can be changed depending on the characteristics of the consultation (the above-mentioned item (4)). The consultation data 1200 and the consultation log 1500 can be used for the calculation of the past processing time.

Further, the expected processing time can be calculated from the adequacy score calculated in Step S108 (the above-mentioned item (5)). This is because the user having a higher adequacy regarding a given question can be expected to be able to answer the question more quickly.

Further, here, the consultation management program 232 can calculate the similarity of the adequacy between users from the user ability data 1100. The similarity of the adequacy is an extent to which fields at which two users are good are similar to each other. For example, in this embodiment, a predetermined number of (for example, 10) attributes corresponding to higher ability scores are extracted from the user ability data 1100 of each user, and it is judged that more attributes common across the extracted ability scores make the similarity higher. However, the method of calculating the similarity of the adequacy is not limited to the above-mentioned method. For example, in order to obtain the similarity of the adequacy, information on an organization chart to which the user belongs and information on a technical community to which the user belongs may be previously registered on the consultation intermediate server 2.

Subsequently, the consultation management program 232 calculates the expected response time of each user regarding the consultation (S110).

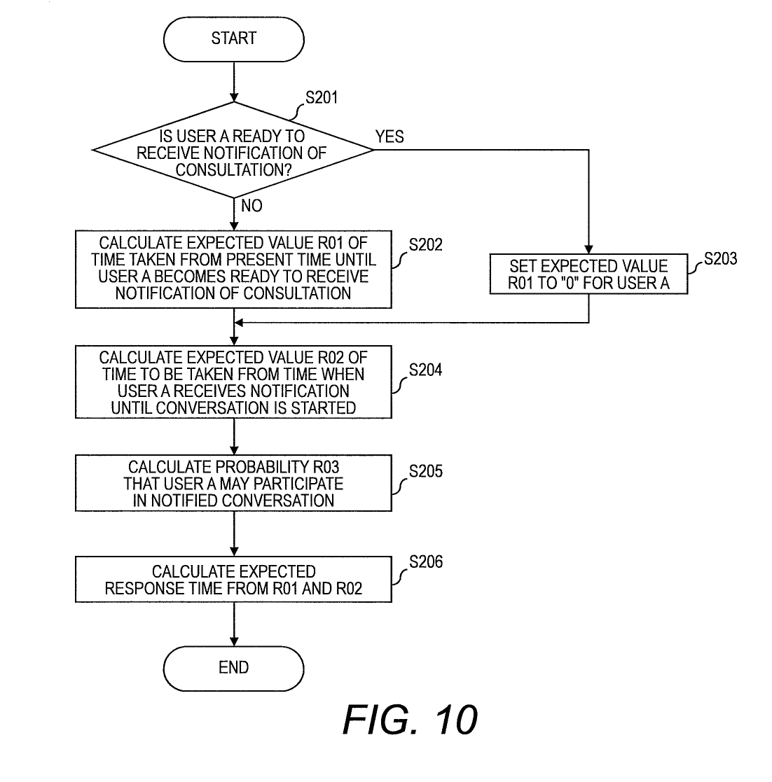

FIG. 10 is a flowchart of an example of a method in which the consultation management program 232 calculates the expected response time of a user A.

First, the consultation management program 232 acquires the presence information 1700 on the user A, and judges whether or not the user A is ready to receive the notification of the consultation (S201). In this embodiment, IM and mail are used for the transmission of the notification of the consultation. Therefore, if the communication methods that can be used currently by the user A include IM or mail, the user A is ready to receive the notification of the consultation.

In a case where the user A is not ready to receive the notification of the consultation, the consultation management program 232 calculates an expected value R01 of a time period taken from the present time until the user A becomes ready to receive the notification of the consultation (S202). The expected value R01 can be calculated based on the presence information log 1800. On the other hand, if the user A is ready to receive the notification of the consultation, the above-mentioned expected value R01 is set to “0” (S203).

An example of a method of calculating the expected value R01 will be shown. First, based on the presence information log 1800, the consultation management program 232 calculates an average value of time periods (unresponsive times) taken from a time when the user A becomes unable to receive the notification of the consultation until the user A becomes ready to receive the notification of the consultation again. It should be noted that the calculation may be performed by using a statistical processing other than the average calculation.

Further, from the presence information log 1800, it is possible to calculate an elapsed time from the last time when the user A becomes unable to receive the notification of the consultation, and to set a difference between the average value of the unresponsive times and the elapsed time as the expected value R01. However, if the expected value R01 is negative (if the unresponsive time is longer than in a normal status), the presence information log 1800 cannot be used for prediction. In that case, the expected value R01 is set to “0” or more. Further, the status of the user is identified based on the presence information, and the expected value R01 may be set to a predetermined value according to the identified status of the user.

Since much time is taken for an analysis of the past unresponsive times, the analysis may be performed in advance by another program (for example, presence information reception program 235). Further, it is possible to calculate the unresponsive times on a time-slot basis or on a day-of-week basis to thereby improve precision of the analysis. For example, it is also possible to calculate the average value of the unresponsive times during each of which the user A is unable to receive the notification of the consultation on Monday morning.

Subsequently, the consultation management program 232 calculates an expected value R02 of a time period (in other words, response time) to be taken from a time when the user A receives the notification until the conversation is started (S204).

An example of a method of calculating the expected value R02 will be shown. First, the consultation management program 232 calculates the response times regarding all the conversations in which the user A has participated so far. The past response time of the user A can be calculated by referencing the consultation log 1500. The past response time may be calculated by calculating a difference between the date and time of a log entry with the type “notify consultation” and the date and time of a log entry with the type “start conversation”.

It should be noted that a log entry with the type “start conversation” does not exist for a conversation in which the user A does not participate (even after receiving the notification). Therefore, the conversation for which the log entry with the type “start conversation” does not exist is not used for the above-mentioned calculation. Accordingly, every average value of the response times can be set as the expected value R02. It should be noted that the calculation may be performed by using a statistical processing other than the average calculation.

It should be noted that, to be simpler, the expected value R02 may be set to the fixed value (for example, 1 minute) set to all users in common or set to each user separately. Further, the status of the user is identified based on the presence information, and the expected value R02 may be set to a predetermined value according to the identified status of the user.

At this time, a probability R03 (response probability R03) that the user A may participate in the notified conversation is not reflected on the expected value R02. The response probability R03 may be calculated (S205) as well as the expected value R02 is calculated. By presenting the response probability R03 to the requester separately from the expected response time, the requester can compare two advisers having the same response time with each other from a new viewpoint of the response probability.

Further, the response time R02 and the response probability R03 may be calculated for each of the characteristics of consultations. This is because each user is characterized by an answering pattern. For example, the question in the field at which the adviser is good can be immediately handled, but the question in the field at which the adviser is weak (of which adviser is not fond) may be delayed. By performing an analysis on the past consultation logs for each of the characteristics of the consultations, the expected value R02 and the response probability R03 can be calculated, which can improve the precision of the expected response time. However, to perform the analysis for each of the characteristics of the consultations, a sufficient number of consultation logs necessary for the analysis need to be collected.

Since much time is necessary for a calculation of the response time and the response probability in the past, the analysis may be performed in advance by another program (for example, conversation log reception program 234). Further, it is possible to calculate the response time and the response probability on a time-slot basis or on a day-of-week basis to thereby increase the precision of the analysis. For example, it is also possible to calculate the average value of the response times and the response probabilities from the log entries with the date and time falling on Monday morning.

Finally, the sum of the expected values R01 and R02 is calculated, and a value of the calculated sum is set as the expected response time of the user A at the present time (S206).

Subsequently, the consultation management program 232 calculates the load on each user at the present time (S111).

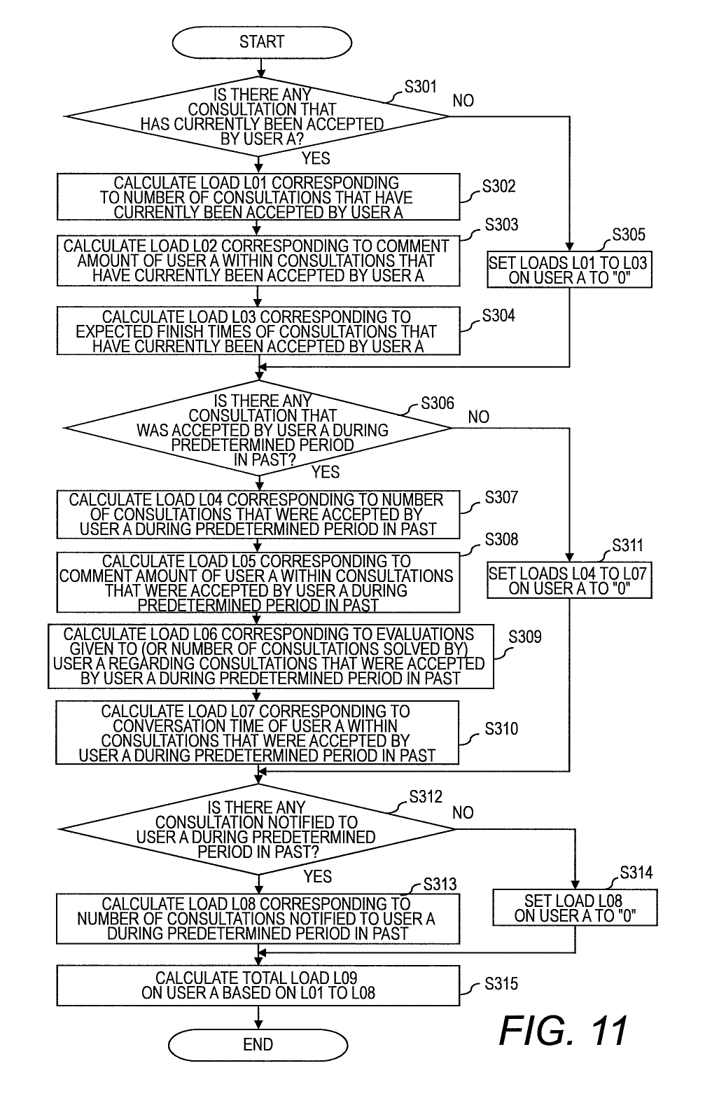

FIG. 11 is a flowchart of an example of a method in which the consultation management program 232 calculates the load on the user A.

The consultation management program 232 does not necessarily calculate all of loads L01 to L08 that will be described below, and one or more of or an arbitrary combination of the loads L01 to L08 can be used depending on required precision of a recommendation. In addition, it is possible to calculate a load defined by a complexly using values used for calculating the loads L01 to L08. For example, the load may be calculated by complexly using the number of consultations that have currently been accepted and the number of consultations that were accepted during a predetermined period in the past.

First, the consultation management program 232 acquires the conversation membership data 1400 on the user A, and judges whether or not the user A has currently accepted any consultation (S301). If there is no consultation that has currently been accepted, the loads L01 to L03 on the user A are all set to “0” (S305). On the other hand, if there is a consultation that has currently been accepted, the loads L01 to L03 are calculated in Steps S302 to S304.

To be specific, if there is a consultation that has currently been accepted, the consultation management program 232 calculates the load L01 corresponding to the number of consultations that have currently been accepted by the user A (S302). The number of consultations that have currently been accepted by the user A can be calculated by referencing the conversation membership data 1400 on the user A.

Subsequently, the consultation management program 232 calculates the load L02 corresponding to a comment amount within the consultations that have currently been accepted (S303). The comment amount can be calculated by referencing the conversation logs 1600 on the user A. The comment amount of the user A in a given conversation can be calculated by any one item of or a combination of two or more items of the following methods:

(1) a method based on the number of times that a comment is made (in the case of IM, number of times that message is transmitted);

(2) a method based on a volume of the comment (in the case of IM, number of characters included in message); and

(3) a method based on a length of the comment (in the case of voice, length of time period during which user A is uttering).

Subsequently, the consultation management program 232 calculates the load L03 corresponding to expected finish times of the consultations that have currently been accepted by the user A (S304). By using the method described in Step S109, the expected processing time of the consultation that has currently been accepted by the user A is calculated, and a difference from the elapsed time of the consultation is calculated. Accordingly, it is possible to calculate the expected finish time of the consultation. If there is a long time period left until the expected finish time, the load L03 is set to a large value, and if there is a short time period left until the expected finish time, the load L03 is set to a small value or “0”. It should be noted that the value of the load L03 is calculated based on the temporal dimension, which makes it easy to add the load on the user A to the expected response time.

Subsequently, the consultation management program 232 acquires the consultation log 1500 on the user A, and judges whether or not there is any consultation that was accepted by the user A during a predetermined period in the past (for example, last one day) (S306). As a result, if there is no consultation that was accepted during the predetermined period, the loads L04 to L07 on the user A are all set to “0” (S311). On the other hand, if there is a consultation that was accepted during the predetermined period, the loads L04 to L07 are calculated in Steps S307 to S310.

To be specific, if there is a consultation that was accepted during the predetermined period, the consultation management program 232 calculates the load L04 corresponding to the number of consultations that were accepted by the user A during the predetermined period (S307). The number of consultations that were accepted by the user A during the predetermined period can be acquired from the consultation logs 1500.

Subsequently, the consultation management program 232 calculates the load L05 corresponding to the comment amount within the consultations that were accepted during the predetermined period (S308). The comment amount within the consultations can be acquired from the conversation logs 1600 on the user A in a similar manner to Step S303.

Subsequently, the consultation management program 232 calculates the load L06 corresponding to evaluations given regarding the consultations that were accepted during the predetermined period (S309). This is because the evaluation given regarding the consultation seems to have a relation with efforts expended by the user A regarding the consultation. Even if the number of consultations solved by the user A is used instead of the evaluation, the same effects seem to be produced. The evaluation given to the user A in the past can be acquired from the evaluation data 1900.

Subsequently, the consultation management program 232 calculates the load L07 corresponding to a conversation time within the consultations that were accepted during the predetermined period (S310). This is because a length of the conversation time seems to have a relation with efforts expended by the user A regarding the consultation. The conversation time within the consultations that were accepted by the user A during the predetermined period can be acquired from the consultation logs 1500.

Subsequently, the consultation management program 232 acquires the consultation log 1500 on the user A, and judges whether or not there is any consultation of which the user A was notified during the predetermined period in the past (for example, last one day) (S312). As a result, if there is no such consultation, the load L08 on the user A is set to “0” (S314). On the other hand, if there is a consultation notified during the predetermined period, the load L08 is calculated in Step S313.

To be specific, if there is a consultation notified during the predetermined period, the consultation management program 232 calculates the load L08 corresponding to the number of consultations of which the user A was notified during the predetermined period (S313). The number of consultations of which the user A was notified during the predetermined period can be acquired from the consultation logs 1500.

Finally, the consultation management program 232 calculates a total load L09 on the user A based on the loads L01 to L08 on the user A (S315). To add the value based on the load to the expected response time to be presented to the requester, the total load on the user A needs to be converted into a time period.

Subsequently, the consultation management program 232 calculates the difficulty of the consultation (S112).

An example of a method of calculating the difficulty of the consultation will be shown. The difficulty of the consultation is calculated based on any one item of or a combination of two or more items of the following data. Only part of the following data items may suffice for the calculation of the difficulty, but the more data items allow the more efficient recommendation.

(1) the difficulty input by the requester

(2) the total number of advisers that received a request notification for the consultation but did not respond thereto

(3) the total number of advisers that accepted the consultation but could not reach the solution

(4) the total comment amount regarding the consultation

(5) the total conversation time regarding the consultation

The consultation management program 232 needs to previously hold a formula used for the calculation of the difficulty. For example, in a case where the item (2) is used for the calculation of the difficulty, the formula may be set as “add “0” to the difficulty if the total number of the item (2) is “0”, add “1” if “1” to “5”, add “2” if “6” to “10”, and add “3” if “11” or more”.

Subsequently, the consultation management program 232 calculates the urgency of the consultation (S113).

An example of a method of calculating the urgency of the consultation will be shown. The urgency of the consultation is calculated based on the deadline 1207 within the consultation data 1200. The consultation management program 232 needs to previously hold a formula used for the calculation of the urgency. For example, the formula may be set as “set the urgency to “0” if the time period left until the deadline is 1 day or more, set the urgency to “1” if less than 1 day and 6 hours or more, set the urgency to “2” if less than 6 hours and 1 hour or more, set the urgency to “3” if less than 1 hour and 30 minutes or more, set the urgency to “4” if less than 30 minutes and 10 minutes or more, and set the urgency to “5” if less than 10 minutes”. Further, if nothing is set as the deadline 1207 within the consultation data 1200, the urgency is set to “0”.

After the above-mentioned steps, the calculations of the values necessary to create the list of advisers are completed.

Then, based on the data items calculated in Steps S108 to S113, the consultation management program 232 creates the list of advisers to be presented to the requester (S114).

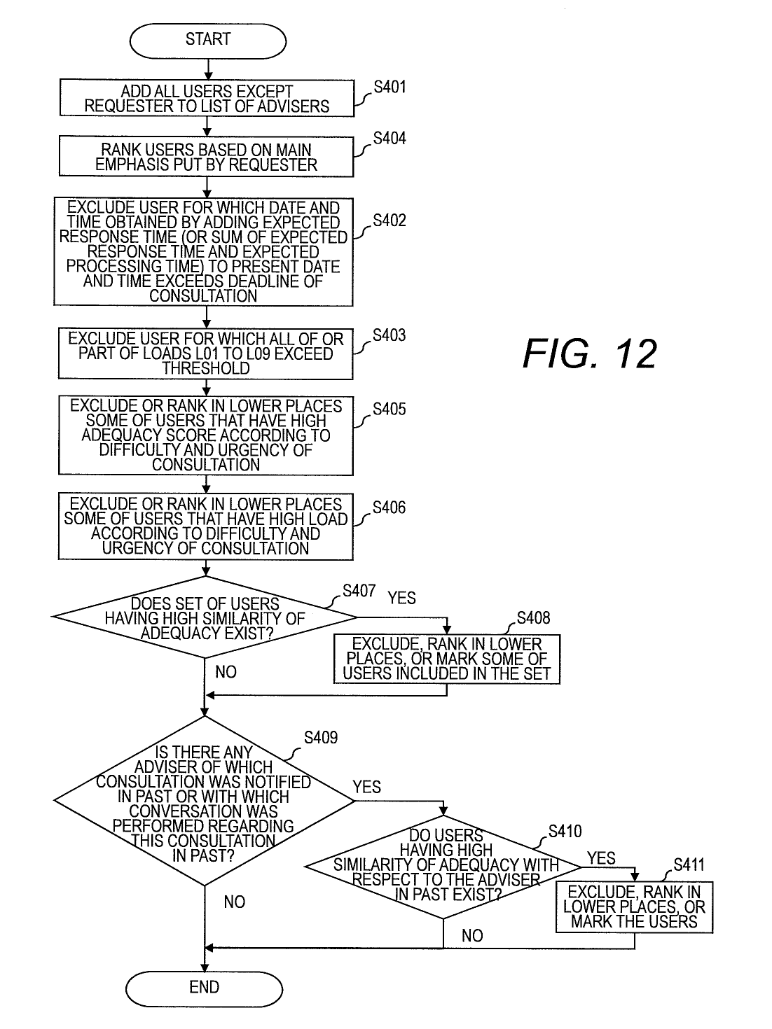

FIG. 12 is a flowchart of an example of a method in which the consultation management program 232 creates the list of advisers.

First, the consultation management program 232 adds all users except the requester to the list of advisers (S401). The data to be added to the list of advisers includes the name and the like acquired from the user data 1000.

Subsequently, the consultation management program 232 ranks the users remaining on the list of advisers based on the main emphasis put by the requester (S404). The main emphasis put by the requester can be acquired from the main emphasis 1208 within the consultation data 1200.

Then, the consultation management program 232 excludes a user for which the date and time obtained by adding the expected response time calculated in Step S110 (or sum of expected response time and expected processing time calculated in Step S109) to the present date and time exceeds the deadline of the consultation (S402). This prevents a useless notification of the consultation from being transmitted to the user assumed to be too late for the deadline specified by the requester.

Subsequently, the consultation management program 232 excludes a user for which all of or part of the loads L01 to L09 exceed a threshold defined according to the system (S403). Accordingly, by preventing the notification of the consultation from being further transmitted to a user having a too high load, it is possible to equalize the load on the respective users.

In the subsequent steps (S405 to S408), in consideration of the efficiency of the entire consultation intermediate system, the consultation management program 232 excludes part of users remaining in the list of advisers or ranks the part of users in lower places. Therefore, the consultation management program 232 can use one of or an arbitrary combination of two or more of Steps S405 to S408. Alternatively, a new ranking rule obtained by complexly using Steps S405 to S408 may be used (for example, simultaneously taking adequacy score and load into account in order to complexly perform Steps S405 and S406).

To exclude the part of users, the number of users remaining in the list of advisers may desirably be taken into account as well. Several users need to remain finally in the list of advisers, and hence, if the number of users remaining in the list of advisers is small, the number of users to be excluded may be reduced.

The consultation management program 232 excludes part of users that have a high adequacy score or ranks the part of users in lower places according to the difficulty and the urgency of the consultation (S405). This is for assigning a simple consultation having a low urgency to an ordinary user as much as possible. To be specific, for example, it is preferable to previously define such rules that “with regard to a question having a difficulty of “0”, do not recommend a user having an adequacy score of “2” or higher (or rank the user having an adequacy score of “2” or higher in a lower place)” and “with regard to a question having a difficulty of “1”, recommend up to two users having an adequacy score of “2” or higher (a user having an adequacy score of “2” or higher other than the above-mentioned 2 users is not recommended or ranked in a lower place for a recommendation)”.

The consultation management program 232 excludes part of users that have a high load or ranks the part of users in lower places according to the difficulty and the urgency of the consultation (S406). This is for assigning a simple consultation having a low urgency to an idle user as much as possible. To be specific, for example, it is preferable to previously define such rules that “with regard to a question having a difficulty of “0”, do not recommend a user having a load of 30 minutes or more (or rank the user having a load of 30 minutes or more in a lower place)” and “with regard to a question having a difficulty of “1”, recommend up to two users having a load of 30 minutes or more (a user having a load of 30 minutes or more other than the above-mentioned two users is not recommended or ranked in a lower place for a recommendation)”.

Subsequently, the consultation management program 232 examines whether or not a set of users having a high similarity of the adequacy exists among the users remaining in the list of advisers (S407). If such a set of users exists, part of users included in the set are excluded from the list of advisers, ranked in lower places, or marked for the requester (S408). This is for preventing a large number of advisers having types similar to one another from being displayed in the list of advisers. In other words, this is because, in some cases, it may be easy for the requester to select advisers if a plurality of advisers having different fields at which the advisers are good can be compared with one another instead of comparing a plurality of advisers having similar fields at which the advisers are good with one another.

It should be noted that it is possible to rank a user included in the set of users having a high similarity of the adequacy in a higher place. This is for obtaining an accurate answer by causing the advisers having types similar to one another to participate and collecting expert opinions.

Subsequently, if there is any adviser of which the question was notified in the past or with which a conversation was performed regarding the question in the past (S409), the consultation management program 232 judges, among the users remaining in the list of advisers, whether or not there exist users having a high similarity of the adequacy with respect to the adviser in the past (S410). If such users exist, the users are excluded from the list of advisers, ranked in lower places, or marked for the requester (S411). This is for preventing the adviser having the similar type from being consulted many times. This is because it seems highly probable that an answer different from the past answer (that did not reach the solution) can be obtained by consulting an adviser having a type different from a type of an adviser in the past rather than by consulting an adviser having a type similar to the type of the adviser in the past.

Then, the consultation management program 232 transmits the list of advisers thus generated to the consultation client of the user terminal 5-1 (S115). After the transmission of the list of advisers, the consultation management program 232 creates an entry of the consultation log with the type “search advisers” (S16).

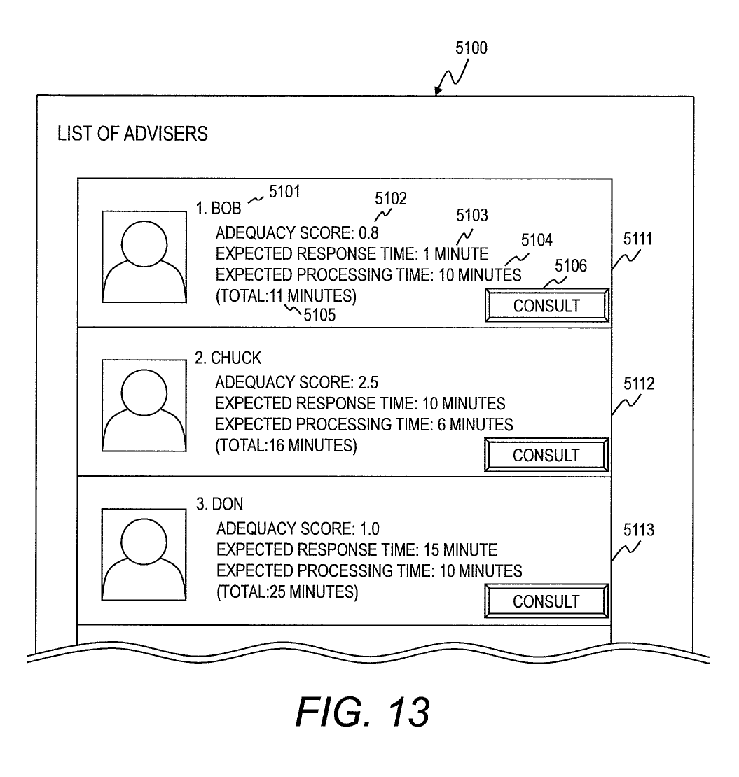

FIG. 13 shows an example of a list-of-advisers screen 5100 displayed by the consultation client.

The list-of-advisers screen 5100 shown in FIG. 13 includes a name 5101 of an adviser, an adequacy score 5102, an expected response time 5103, an expected processing time 5104, a sum value 5105 of the expected response time and the expected processing time, and a button 5106 for instructing to transmit the notification of the consultation to each adviser.

The requester selects an adviser whom the requester wishes to consult from among adviser candidates displayed in the list of advisers, and instructs to transmit the notification of the consultation to the adviser (SI 17). To explicitly select the adviser, with reference to the list of advisers, the requester can select the adviser based on information (such as acquaintances of the requester) that is not held by the consultation intermediate server 2.

It should be noted that, instead of having the requester select the adviser, the consultation intermediate server can automatically select the adviser on top of the list of advisers. The automatic selection of the adviser can eliminate time and labor for comparing and examining the advisers from the requester.

In this embodiment, description will be made of a case where the requester explicitly selects the user (Bob) with the user ID “bob@example.com” as the first adviser.

Subsequently, the consultation client of the user terminal 5-1 transmits the consultation start request to the consultation intermediate server 2 (S118). The consultation start request includes a value for identifying the adviser (such as user ID of adviser or rank in list of advisers transmitted in Step S115).

Upon reception of the consultation start request, the consultation management program 232 selects the communication method for transmitting the notification of the consultation to the requester and the specified adviser (S119). First, the consultation management program 232 acquires the communication methods that can currently be used by each user from the presence information 1700. Then, it is judged whether or not the communication method that can be supported by the consultation notification program 233 is included in those communication methods. In this embodiment, both the requester (Andy) and the adviser (Bob) can use IM, the notification of the consultation for the requester and the adviser is transmitted to the IM client of each user through the IM server 7 (S120 to S123).

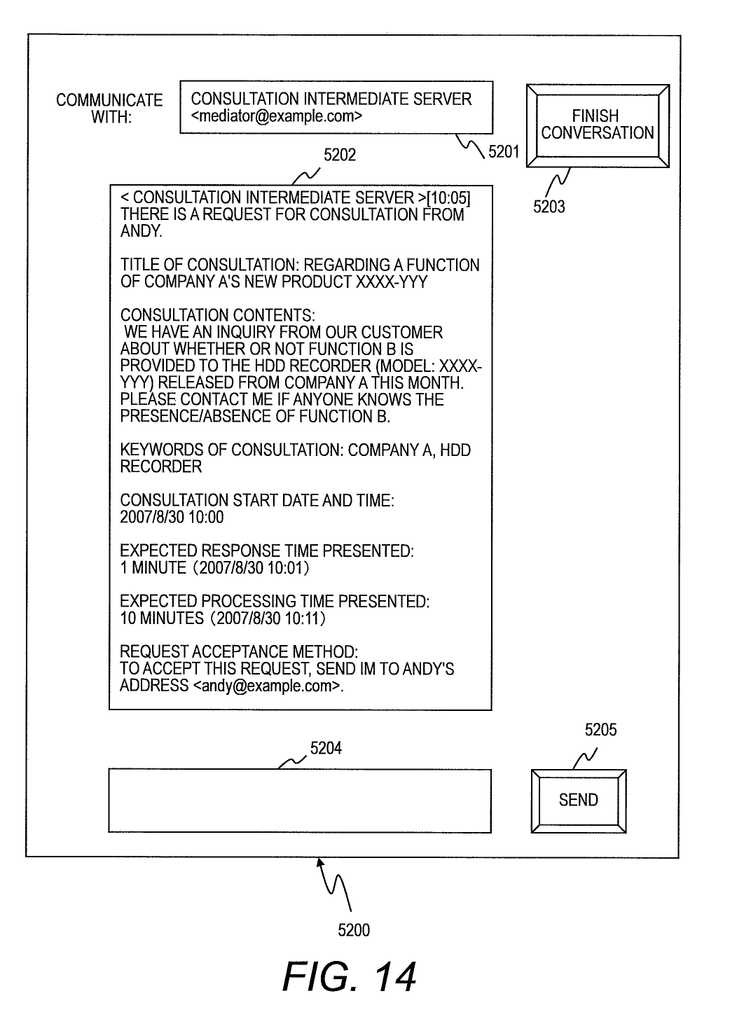

FIG. 14 shows an example of a notification-of-consultation display screen 5200 on which the IM client displays the notification of the consultation, showing a display example of the notification of the consultation transmitted to the adviser (Bob).

The notification-of-consultation display screen 5200 shown in FIG. 14 includes a display field 5201 for displaying the other end of a communication, a message display field 5202, a button 5203 for instructing to finish the conversation, an input field 5204 for a message to be transmitted from the adviser, and a button 5205 for transmitting the message.

The message display field 5202 includes the title of the consultation, the contents of the consultation, keywords of the consultation, a consultation start date and time, the expected response time presented to the requester, the expected processing time presented to the requester, and a method of receiving a request from the requester (identifier used for communicating with requester). By thus presenting the expected response time and the expected processing time to the adviser, the adviser can judge how urgently the adviser should answer (or how much time is allowed before answering).

After finishing the transmission of the notifications of the consultation, the consultation management program 232 creates entries of the consultation log with the type “notify consultation” for the number of the transmitted notifications of the consultation (S124). Further, items of the conversation data and the conversation membership data are added (S125).

However, if the user cannot use IM and can only use mail, the notification of the consultation is transmitted to the user through the mail server 8 (S126 and S127). By thus transmitting the notification of the consultation by using a plurality of communication methods, it is possible to increase the number of advisers that can answer the consultation across the entire system.

Further, if the user cannot use mail or IM, the notifications of the consultation for the user are temporarily accumulated in the database 230 as the delayed notification data 2000 (with the wait time set to “0”). The delayed notification program 236 transmits the accumulated notifications of the consultation when the user becomes ready to receive the notification of the consultation by mail or IM.

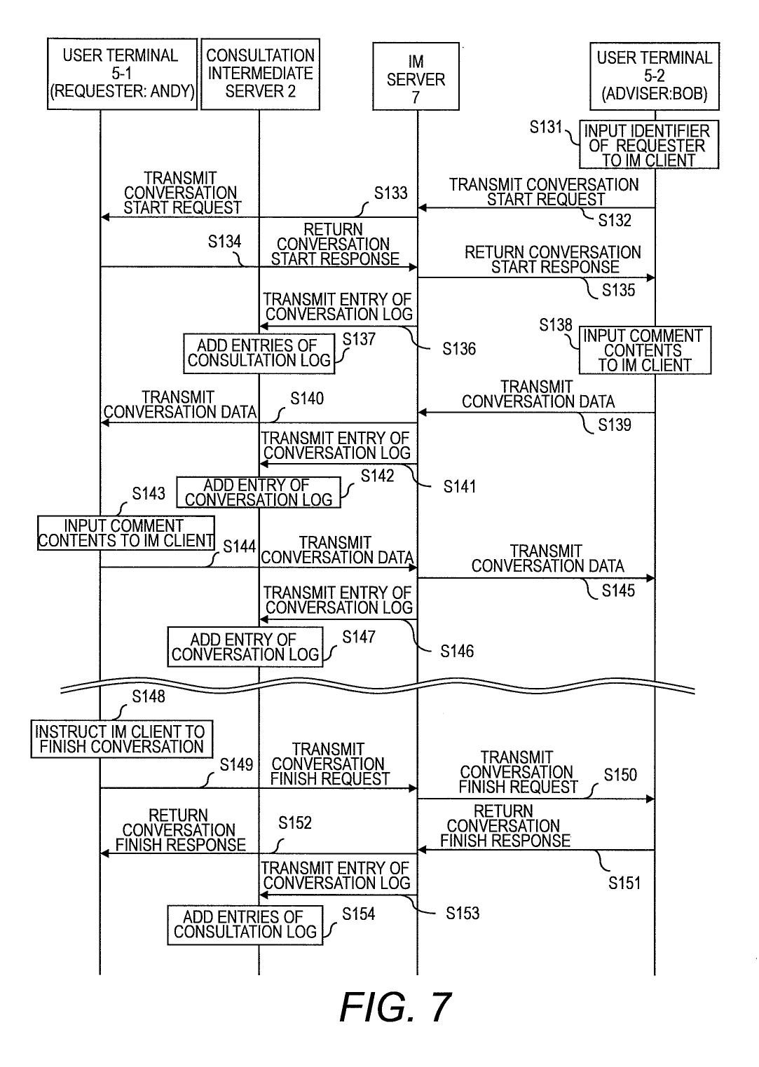

FIG. 7 is a sequence diagram showing an example of an operation performed during a conversation between the requester and the adviser.

In a case where the adviser views the notification and decides to accept the consultation from the requester, the adviser first inputs the identifier of the requester included in the notification to the IM client (S131).

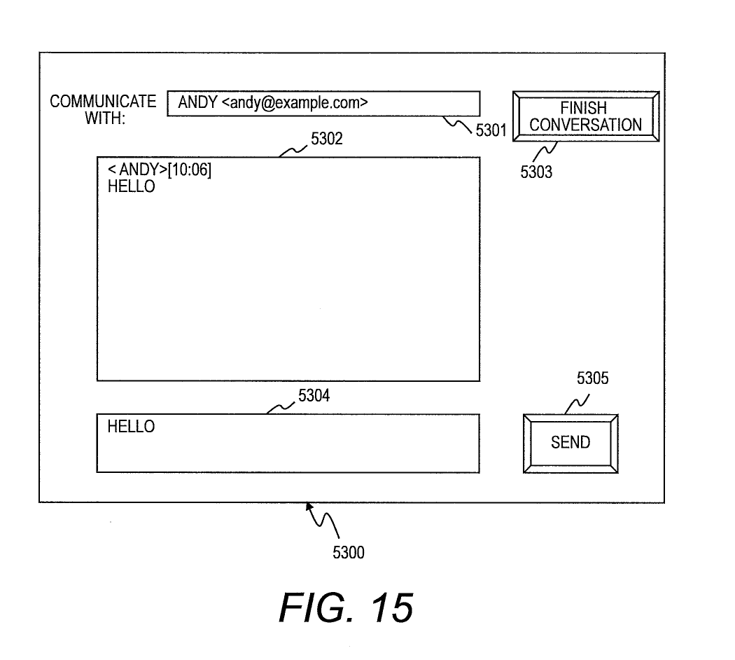

FIG. 15 shows an example of a conversation screen 5300 displayed by the IM client, showing an example of the screen displayed on a terminal of the adviser (Bob).

The conversation screen 5300 shown in FIG. 15 includes an input field 5301 for an identifier of the other end of a communication, a display field 5302 for the past conversation data, a conversation finish button 5303 for instructing to finish the conversation, an input field 5304 for own comment contents, and a button 5305 for instructing to transmit the own comment contents. The adviser inputs the notified identifier of the requester to the input field 5301. Upon reception of the notification, the inputting may be performed by the IM client automatically or semi-automatically (for example, automatically performed when identifier displayed in message display field 5202 is clicked on).

When the adviser inputs the identifier of the requester to the IM client, the IM client on the user terminal 5-2 transmits a conversation start request to the IM server 7 (S132). The conversation start request includes the identifier of the user (Bob) that has started the conversation, and the identifier of the user (Andy) serving as the other end of the conversation. The IM server program 731 on the IM server 7 transmits the conversation start request to the IM client on the user terminal 5-1 (S133).

The IM client on the user terminal 5-1, if in the status “free to chat”, returns a conversation start response to the IM server 7 (S134). The conversation start response also includes the identifier of the user (Bob) that has started the conversation, and the identifier of the user (Andy) serving as the other end of the conversation. The IM server program 731 transmits the conversation start response to the IM client on the user terminal 5-2 (S135).

The above-mentioned steps complete the procedure for starting the conversation.

After the procedure for starting the conversation has been completed, the IM server program 731 records in the database 730 that the conversation is to be performed between the user terminal 5-1 and the user terminal 5-2. This is a processing generally performed by the IM server in order to forward the subsequent items of the conversation data.

In addition, the IM server program 731 transmits entries of the conversation log with the type “start conversation” to the conversation log sending program 732. The log acquisition is an operation specific to this embodiment. Here, since the requester and the adviser simultaneously participated in the conversation, two entries of the conversation log corresponding to the two users are transmitted. The conversation log sending program 732 transmits those entries of the conversation log to the conversation log reception program 234 on the consultation intermediate server 2 (S136).

Upon reception of the entries of the conversation log, the conversation log reception program 234 generates entries of the consultation log with the type “start conversation” which correspond to the received entries of the conversation log (S137).

After that, if the user (requester or adviser) wishes to make a comment, the user inputs the comment contents to the IM client, and transmits an instruction to transmit the input comment (S138 and S143). Upon reception of the instruction to transmit the comment contents, the IM client transmits the conversation data to the IM server 7 (S139 and S144). The conversation data includes an identifier of a transmission source of the conversation data, an identifier of a transmission destination, and the comment contents. The IM server program 731 on the IM server 7 forwards the conversation data to the other IM client (S140 and S145). Further, the IM server program 731 sends an entry of the conversation log with a type “conversation data” to the conversation log sending program 732. The entry of the conversation log with the type “conversation data” includes the identifier of the transmission source of the conversation data, the identifier of the transmission destination, and the comment contents. The conversation log sending program 732 transmits the entry of the conversation log to the conversation log reception program 234 on the consultation intermediate server 2 (S141 and S146). Upon reception of the entry of the conversation log, the conversation log reception program 234 adds the received entries of the conversation log to the conversation log (S142 and S147).

By repeating the exchange of the conversation data by the procedure described above, sooner or later, the problem of the requester is solved, or it turns out to be less likely for the problem to be solved. At this time, any one of the requester and the adviser performs a procedure for finishing the conversation.

In a case where the requester decides to finish the conversation, the requester first instructs the IM client to finish the conversation (S148). On the screen example shown in FIG. 15, the conversation finish button 5303 is operated to instruct to finish the conversation.

After the requester instructs to finish the conversation, the IM client on the user terminal 5-1 transmits a conversation finish request to the IM server 7 (S149). The conversation finish request includes the identifier of the user (Andy) that has instructed to finish the conversation and the identifier of the other end of the conversation (Bob). The IM server program 731 on the IM server 7 transmits the conversation finish request to the IM client on the user terminal 5-2 (S150).

Upon reception of the conversation finish request, the IM client on the user terminal 5-2 closes the conversation screen, and returns a conversation finish response to the IM server 7 (S151). The conversation finish response is transmitted to the IM client on the user terminal 5-1 through the IM server program 731 (S152). Upon reception of the conversation finish response, the IM client on the user terminal 5-1 closes the conversation screen.

The above-mentioned steps complete the procedure for finishing the conversation.

After the procedure for finishing the conversation has been completed, the IM server program 731 deletes the data of the conversation performed between the user terminal 5-1 and the user terminal 5-2 from the database 730. This is a processing generally performed by the IM server in order to prevent the subsequent items of the conversation data from being forwarded. In addition, the IM server program 731 transmits entries of the conversation log with the type “finish conversation” to the conversation log sending program 732. This processing is an operation specific to this embodiment.

In the above description, since the requester and the adviser simultaneously finished the conversation, two entries of the conversation log corresponding to the two users are transmitted. The conversation log sending program 732 transmits those entries of the conversation log to the conversation log reception program 234 on the consultation intermediate server 2 (S153). Upon reception of the entries of the conversation log, the conversation log reception program 234 adds entries of the consultation log with the type “finish conversation” which correspond to the received entries of the conversation log (S154).

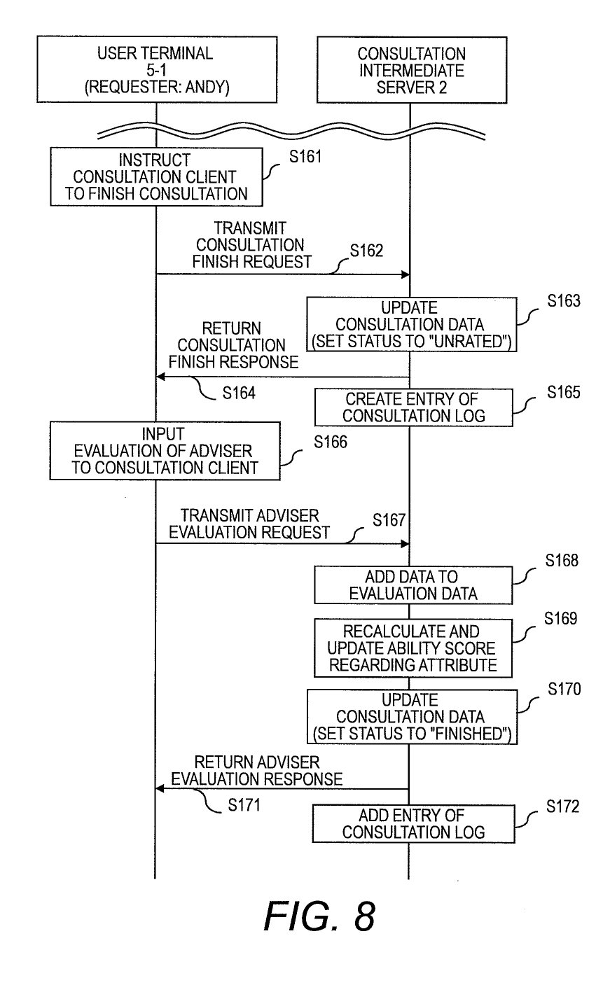

FIG. 8 is a sequence diagram showing an example of an operation performed from when the requester instructs to finish the consultation until the requester evaluates the adviser.

After performing the conversation with an adviser once, the requester is allowed to select the next action from two options. One is an option for searching advisers for another new one, and is selected in a case where the consultation has not yet been solved. The other is an option for finishing the consultation, and is selected in a case where the consultation has been solved or the solution of the consultation has been given up.

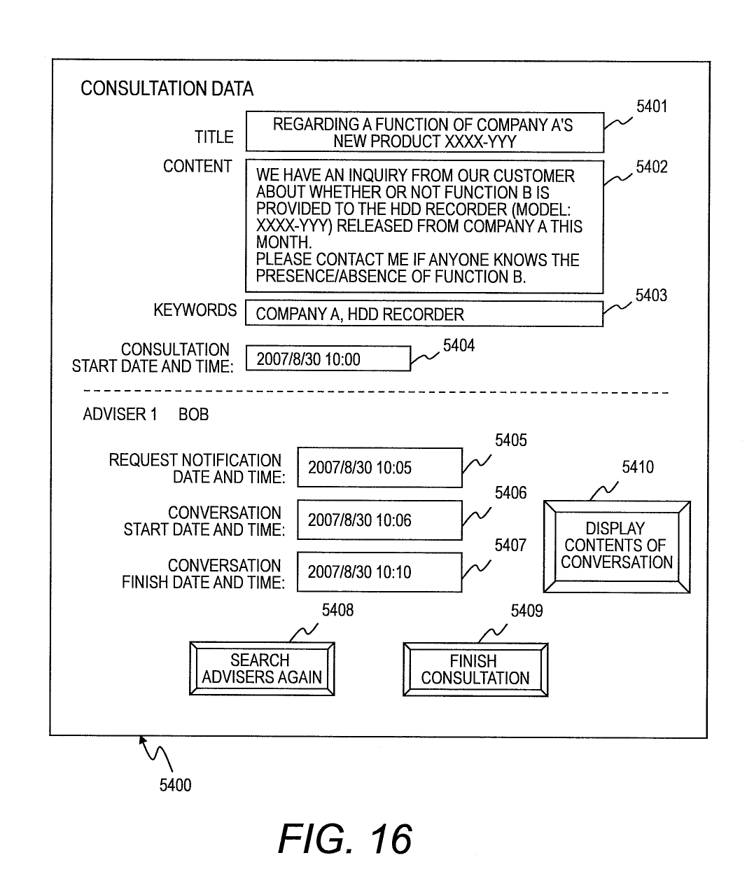

FIG. 16 shows an example of a consultation data display screen 5400 for selecting the next action, which is displayed by the consultation client of the requester.

The consultation data display screen 5400 shown in FIG. 16 includes an input field 5401 for the title of the consultation, an input field 5402 for the contents of the consultation, an input field 5403 for the keywords of the consultation, a display field 5404 for the consultation start date and time, a request notification date and time 5405 with respect to the adviser, a conversation start time 5406, a conversation finish time 5407, a search-advisers-again button 5408, a consultation finish button 5409, and a display instruction button 5410 for the contents of the conversation.

When the requester operates the search-advisers-again button 5408, Steps S106 to S115 of FIG. 6A are performed again. It should be noted that the presence information and the like have changed according to the elapse of time, and hence it is highly possible that the list of advisers is not the same as before.

On the other hand, when the requester operates the consultation finish button 5409, a procedure for finishing the consultation is started.

In other words, when the requester instructs the consultation client to finish the consultation (S161), the consultation client transmits a consultation finish request to the consultation intermediate server 2 (S162). The consultation finish request includes the consultation ID (in this embodiment, “50”) of the consultation.

Upon reception of the consultation finish request, the consultation management program 232 on the consultation intermediate server 2 updates the status of the consultation specified by the consultation finish request into “unrated” (S163).

After updating the consultation data, the consultation management program 232 returns a consultation finish response to the consultation client of the user terminal 5-1 (S164). Then, after transmitting the consultation finish response, the consultation management program 232 creates an entry of the consultation log with the type “finish consultation” (S165).

After finishing the consultation, the requester can evaluate the adviser that has accepted the consultation. To evaluate the adviser, the requester inputs the evaluation of each adviser to the consultation client (S166).

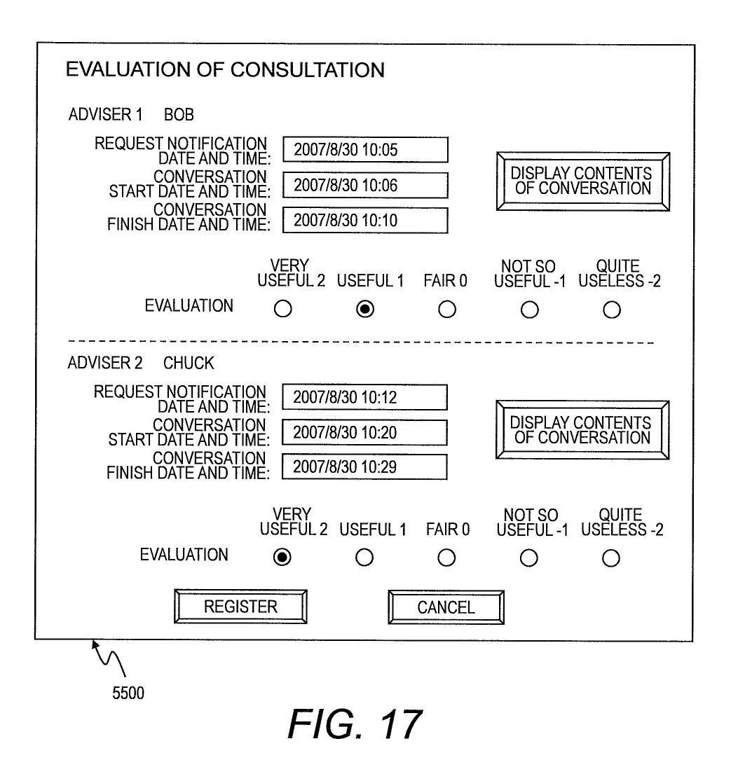

FIG. 17 shows an example of a screen for inputting the evaluation of the adviser, which is displayed by the consultation client.

In this embodiment, the evaluation of the adviser is input on a five-level scale. Further, in this embodiment, description will be made of a case where the adviser subsequent to Bob, who is called Chuck, is consulted (this is why two advisers are displayed).

After the requester inputs the evaluation of the adviser to the consultation client, the consultation client transmits an adviser evaluation request to the consultation intermediate server (S167). The adviser evaluation request includes the consultation ID (in this embodiment, “50”) of the consultation, the identifier (such as the user ID or a sequence number in a case where the consultation is notified) of each adviser, and an evaluation value (in this embodiment, value ranging from “−2” to “2”). Upon reception of the adviser evaluation request, the consultation management program 232 on the consultation intermediate server 2 adds data included in the adviser evaluation request to the evaluation data 1900 (S168).

In a case where the consultation intermediate server 2 has created the user ability data 1100 based on the evaluation data 1900, in this step, the ability score within the user ability data on each adviser is recalculated (S169). To be specific, the ability score is recalculated as follows. First, all of the consultations regarding which the evaluations of Bob have been performed are extracted from among consultations having the same keyword as the keyword “Company A” of the current consultation. Then, an average value of the evaluations regarding those consultations is calculated, and is set as the ability score of Bob regarding the attribute “Company A”. Then, the calculated ability score is stored in the user ability data 1100. The recalculations are performed similarly on combinations of the keyword “Company A” and Chuck, the keyword “HDD recorder” and Bob, and the keyword “HDD recorder” and Chuck.

After finishing the above-mentioned processing, the consultation management program 232 updates the status of the consultation into “finished” (S170). Then, the consultation management program 232 returns an adviser evaluation response to the consultation client of the user terminal 5-1 (S171). Then, after transmitting the adviser evaluation response, the consultation management program 232 creates an entry of the consultation log with the type “evaluate advisers” (S172).

After the above-mentioned steps, the consultation using IM is completed.

As described above, in the first embodiment, the consultation intermediate server 2 presents the requester with the expected response time and/or the expected processing time of each adviser, which allows the requester to select the adviser from a new viewpoint of time. Accordingly, the adviser is selected not only from the viewpoint that the ability of the adviser is high but also from the viewpoint that the response time and the processing time of the adviser are short, which can reduce the load on the adviser having a high ability. In addition, before starting the consultation in actuality, the requester can estimate a time period necessary for the solution of the problem based on the expected response time and the expected processing time. Accordingly, it is possible to improve the usability of the system.

Further, based on the load converted into a numerical value, the consultation intermediate server 2 changes a display order in the list of advisers to be recommended to the requester, or excludes the adviser on which a high load is imposed from the list of advisers. This can reduce the requests for a consultation to be made to the adviser on which a high load is imposed, which can reduce the load on the adviser having a high ability.

In addition, the consultation intermediate server 2 can display the value of the expected response time to which the load converted into a numerical value is added. Accordingly, it is possible to reduce the requests for a consultation to be made to the adviser having a high ability.

Further, the consultation intermediate server 2 can recommend the adviser with more efficiency by taking the difficulty of the consultation and/or the deadline for the solution of the consultation into consideration. It is less necessary to depend on the adviser having a high ability with regard to a simple consultation and a consultation with the deadline for the solution of the consultation being far off. Therefore, the consultation intermediate system recommends an ordinary adviser as much as possible with regard to the simple consultation and the consultation with the deadline being far off. On the other hand, the consultation intermediate server 2 recommends the adviser having a high ability with regard to a difficult consultation, and the adviser having a short expected response time and a high ability with regard to a consultation with the early deadline. Accordingly, it is possible to reduce the load on the adviser having a high ability.

### Second Embodiment

The first embodiment has been described above by taking the example of the consultation intermediate system that uses the one-to-one communication method. The second embodiment will be described by taking a consultation intermediate system that uses a one-to-many communication method as an example.

FIG. 29 is a configuration diagram showing a configuration of a communication network according to the second embodiment of this invention.

The consultation intermediate system according to the second embodiment of this invention includes the communication network 1, the consultation intermediate server 2, the n user terminals 5-1 to 5-n, the presence server 6, the mail server 8, and a multi-user chat server 9.

The consultation intermediate server 2, the multi-user chat server 9, the mail server 8, the presence server 6, and the n user terminals 5 are coupled to one another via the physical communication line 10 and the communication network 1.

In this embodiment, multi-user chat is used for the conversation between the users, and an invitation function of the multi-user chat and electronic mail are used for the notification of the consultation. Therefore, in this embodiment, the multi-user chat server 9 is operated as the conversation server 3 and the consultation notification server 4. In addition, the mail server 8 is operated as the second consultation notification server 4. On each of the user terminals 5, a multi-user chat client runs as the conversation client and the consultation notification client, and the mail client runs as the spare consultation notification client. Further, among the users having two or more user terminals, there may be the user having the user terminal (for example, cellular phone) on which only the mail client runs.

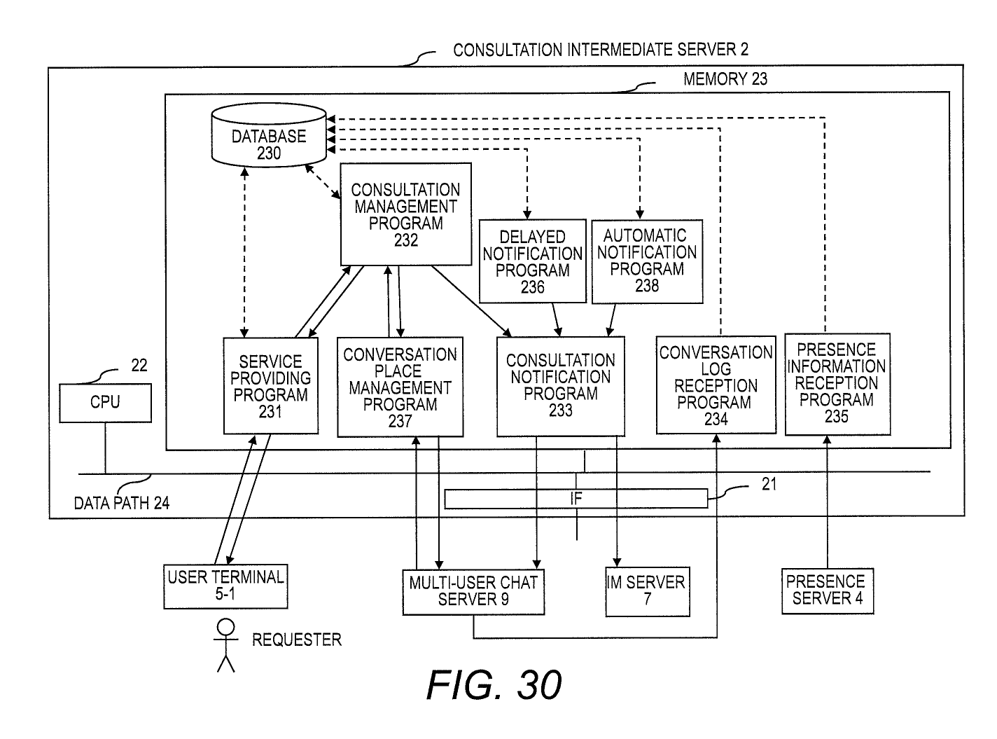

FIG. 30 is a functional block diagram showing a configuration of the consultation intermediate server 2 according to the second embodiment of this invention. It should be noted that the same components as those of the consultation intermediate server 2 according to the first embodiment (FIG. 4) are denoted by the same reference numerals, and description thereof will be omitted.

In addition to the functions of the consultation intermediate server 2 according to the first embodiment, a conversation place management program 237 and an automatic notification program 238 are stored in the memory 23. The database 230 holds all of the same data as in the first embodiment.

However, a new column for storing a presence/absence of an automatic notification is added to the consultation data 1200. The automatic notification program 238 automatically and repeatedly searches for a new adviser regarding a consultation with a value “automatic notification: on” in the column for storing the presence/absence of an automatic notification, and transmits the notification of the consultation to one or more advisers.

In addition, a new column for storing a conversation place ID is added to the conversation data 1300, and the conversation place ID is stored in the new column. The conversation place ID is an identifier for identifying a virtual place used for a one-to-many conversation. In this embodiment, a chat room for a multi-user chat is used as a virtual conversation place, and hence the conversation place ID represents a chat room ID. In this embodiment, a character string conforming to the same format as an email address is used as the chat room ID.

The conversation place management program 237 is a program for performing procedures for starting and finishing a conversation place (chat room). The conversation place management program 237 communicates with a management service providing program 933 on the multi-user chat server 9.

The automatic notification program 238 is a program for automatically searching, if desired by the requester, for a new adviser based on the status of a consultation and transmitting the notification of the consultation to one or more advisers.

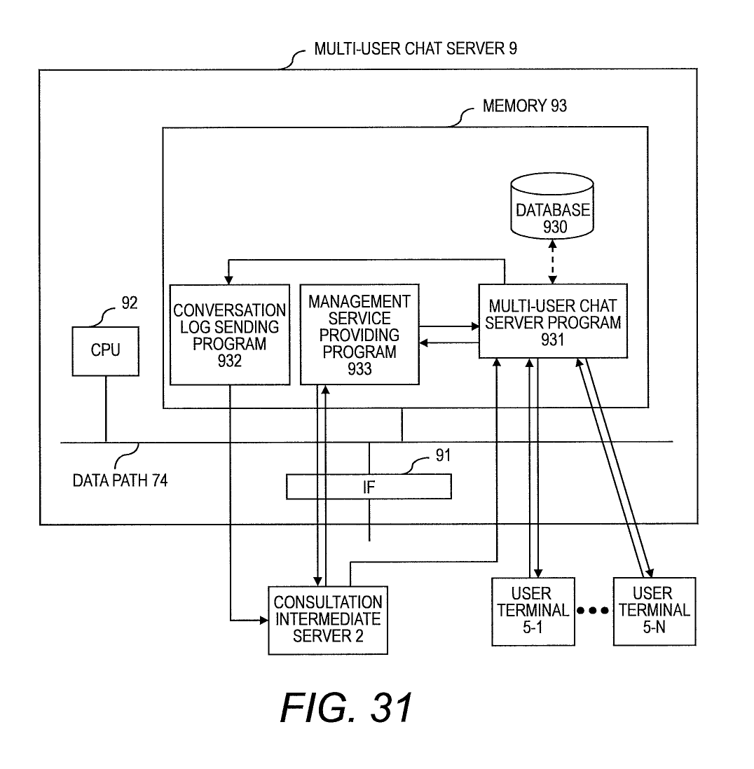

FIG. 31 is a functional block diagram showing an internal configuration of the multi-user chat server 9 according to the second embodiment of this invention.

The multi-user chat server 9 includes an IF 91, a CPU 92, and a memory 93, and the IF 91, the CPU 92, and the memory 93 are coupled to one another via a data path 94.

The multi-user chat server 9 transmits/receives a packet via the IF 91. Each of the programs executed on the multi-user chat server 9 is stored in the memory 93. At an operation of the multi-user chat server 9, the CPU 92 reads and executes the programs stored in the memory 93 via the data path 94. The arrows within the figure indicate flows of data among the programs. Of those, the dotted arrows within the figure indicate database operations.

A database 930, a multi-user chat server program 931, a conversation log sending program 932, and a management service providing program 933 are stored in the memory 93.

The database 930 holds data necessary to run the multi-user chat server program 931. The data held in the database 930 includes account information on the multi-user chat server, but does not include the data specific to this embodiment. Accordingly, detailed description of the held data will be omitted.

The multi-user chat server program 931 is a program for performing transmission/reception of a message to/from the multi-user chat client running on each user terminal 5. Based on the chat room ID included in the conversation data, the multi-user chat server program 931 forwards the conversation data transmitted from one multi-user chat client to the rest of participants belonging to the chat room. The forwarding is a general operation of the multi-user chat server.

The conversation log sending program 932 and the management service providing program 933 are programs specific to this embodiment. The conversation log sending program 932 is a program for transmitting the conversation log to the consultation intermediate server 2. Before forwarding the conversation data, the multi-user chat server program 931 shapes the contents into the form of the conversation log, and transmits the conversation log to the conversation log sending program 932. The management service providing program 933 is a program for providing the consultation intermediate server 2 with a function of starting and finishing a chat room.

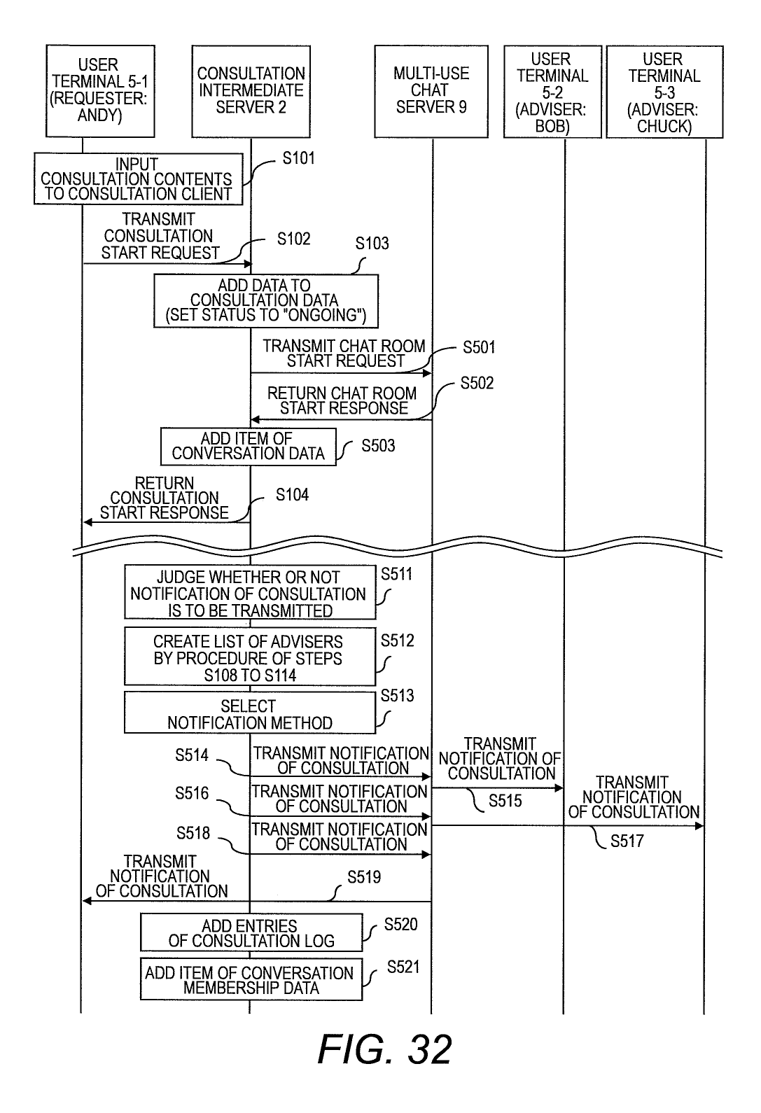

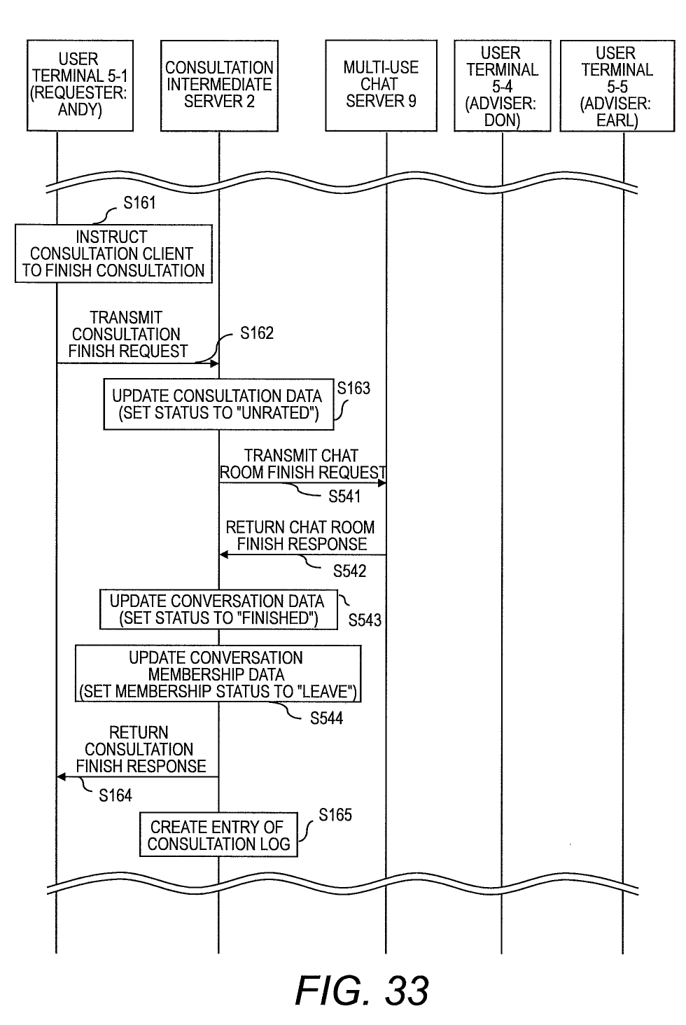

FIG. 32 and FIG. 33 are sequence diagrams showing examples of operations performed from the start of a consultation to the finish thereof according to the second embodiment of this invention. In this example, description will be made of the case where the requester (Andy) who has the user ID “andy@example.com” and uses the user terminal 5-1 starts the consultation. It should be noted that the same steps as those in the first embodiment are denoted by the same reference symbols as in FIGS. 6A, 6B, 7, and 8, and description thereof will be omitted.

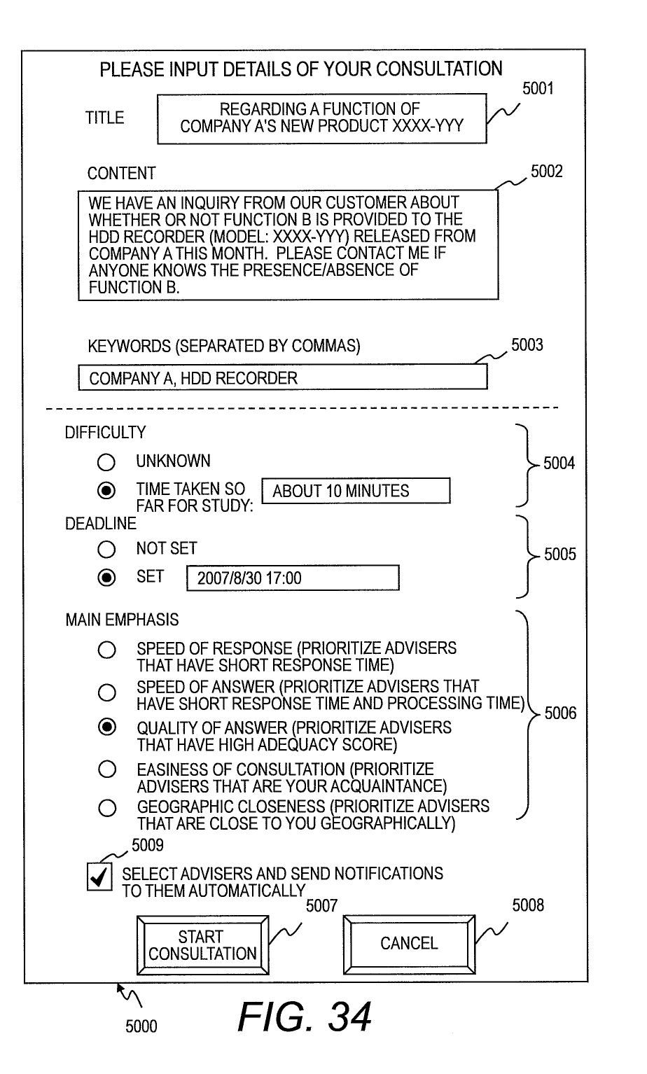

FIG. 34 shows an example of the input screen 5000 for the consultation contents according to the second embodiment of this invention.

In the second embodiment, the input screen 5000 for the consultation contents is partially changed.

The input screen 5000 for the consultation contents according to the second embodiment shown in FIG. 34 includes input fields for the title 5001 of a consultation, the contents 5002 of the consultation, the keywords 5003 indicating characteristics of the consultation, the difficulty 5004 of the consultation, the deadline 5005 for solution of the consultation, the main emphasis 5006 put by the requester, and a presence/absence of an automatic notification 5009. In addition, the input screen 5000 includes the consultation start button 5007 and the cancel button 5008.

The presence/absence of an automatic notification 5009 is a check box for inputting the presence/absence of an automatic notification. In Step S103, a value of the check box is stored in the new column for storing a presence/absence of an automatic notification, which has been added to the consultation data 1200.

In addition, in the second embodiment, the chat room is prepared after the addition to the consultation data 1200 (S103). In order to create a chat room to be used for the consultation, the consultation management program 232 instructs the conversation place management program 237 to create a chat room. The conversation place management program 237 transmits a chat room start request to the management service providing program 933 on the multi-user chat server 9 (S501). The chat room start request may include data on the consultation (for example, the title of the consultation is specified as a title of the chat room).

The management service providing program 933 creates a new chat room through the multi-user chat server program 931, and returns a chat room start response (S502). The chat room start response includes an ID of the newly-started chat room. The management service providing program 933 returns the chat room ID to the consultation management program 232. Then, the consultation management program 232 adds the conversation data including the chat room ID (S503). The above-mentioned steps complete the preparation of the chat room.

A method of transmitting the notification of the consultation to the adviser is different depending on whether or not the automatic notification is turned on in Step S101.

If the automatic notification is not turned on, the notification of the consultation is transmitted by the same procedure as that of the first embodiment. First, the requester instructs the consultation client to search advisers, and obtains the list of advisers. The data used for generating the list of advisers is the same as that of the first embodiment.

The requester selects one or more advisers from the list of advisers. At this time, the consultation client calculates the expected response time and the expected processing time based on the assumption that the notification of the consultation is transmitted to all of the selected advisers. The following are examples to be calculated as those time periods.

(1) a time period taken until the response is returned from at least N advisers among the selected advisers (N is a numerical value equal to or larger than 1)

(2) a time period taken until the consultation is solved by at least N advisers among the selected advisers (N is a numerical value equal to or larger than 1)

(3) an average value of the expected response times of the selected advisers

(4) an average value of the expected processing times of the selected advisers

Accordingly, by presenting the requester with the expected response time and the expected processing time in a whole group of advisers, the requester can estimate the time period taken until the problem is solved with more simplicity.

After the requester has selected the adviser, the consultation intermediate server 2 transmit the notification of the consultation to the selected adviser. In the second embodiment, the chat room ID acquired in Step S502 is stored in the notification of the consultation. Therefore, all of the requesters and the advisers are collected in the same chat room.

On the other hand, if the automatic notification is turned on, the automatic notification program 238 automatically transmits the notification of the consultation. The automatic notification program 238 is activated periodically (for example, per predetermined intervals) and/or when a new entry of the conversation log is received. The activated automatic notification program 238 judges whether or not the notification of the consultation is to be transmitted with regard to each item of the consultation data for which the automatic notification is turned on (S511).

In order to prevent the number of advisers from deviating between consultations, the automatic notification program 238 examines any one of or a combination of two or more of the following items.

(1) the number A01 of advisers to whom the notification of the consultation was transmitted during the predetermined period in the past

(2) the number A02 of advisers who participated in the conversation place for the consultation during the predetermined period in the past

(3) the number A03 of advisers who are currently participating in the conversation place for the consultation

(4) the number A04 of advisers to whom the notification of the consultation has been transmitted from the consultation start to the present time

(5) the number A05 of advisers who have participated in the consultation so far since the consultation start

The items (1) and (2) are examined with regard to participation frequencies of the advisers. If a large number of new advisers participate in the conversation place at one time, the users may find it hard to communicate with one another, and hence a limitation is placed on the number of newly-participating advisers. This prevents a situation where the question drags on with the result that a large number of advisers are unnecessarily invited. The numbers A01 and A02 can be calculated from the consultation log 1500.

The item (3) is examined in order to prevent a large number of advisers from simultaneously participating in the conversation. If the large number of advisers simultaneously participate in the conversation, the users may find it hard to communicate with one another, and hence a limitation is placed on the number of advisers who can chat simultaneously. This prevents the situation where the question drags on with the result that the large number of advisers are unnecessarily invited. The number A03 can be calculated from the conversation membership data 1400.

The items (4) and (5) are examined with regard to the number of advisers involved in the consultation. By placing a limitation on the number of advisers regarding a consultation, the number of advisers is prevented from deviating between consultations. The numbers A04 and A05 can be calculated from the conversation membership data 1400.

The automatic notification program 238 sets thresholds T01 to T05 common across the system in correspondence with the numbers A01 to A05, respectively. The thresholds may vary depending on the difficulty and/or the urgency of the consultation. In that case, the more important consultation can collect the more advisers.

If any one of the values of the numbers A01 to A05 exceeds the threshold, no new adviser is invited. On the other hand, if all of the values of the numbers A01 to A05 are below the threshold, the minimum value among values obtained by the subtractions T01-A01, T02-A02, T03-A03, T04-A04, and T05-A05 is set as the number N of advisers to whom the notification of the consultation can be newly transmitted.

If N is 1 or more, the automatic notification program 238 creates the list of advisers by the same procedure as that of the first embodiment (S108 to S114) (S512). Then, a method of the notification of the consultation to the advisers is selected (S513). Then, the notification of the consultation is transmitted to the top N advisers in the list of advisers (S514 to S517). In the example of FIG. 32, the notification of the consultation is transmitted to the user (Bob) with the user ID “bob@example.com” and the user (Chuck) with the user ID “chuck@example.com”.

If the notification of the consultation has not yet been transmitted to the requester, the consultation intermediate server 2 also transmits the notification of the consultation to the requester (S518 and S519). In transmitting the notification of the consultation, the consultation intermediate server 2 adds entries of the consultation logs and entries of the conversation membership data in the same manner as in the first embodiment (S520 and S521).

It should be noted that, even if the automatic notification is turned on, the requester may transmit the notification of the consultation by the same procedure as that of the first embodiment. In that case, there can be provided an option for allowing the requester himself/herself to select the adviser from the list of advisers if the automatic notification does not recommend a good adviser.

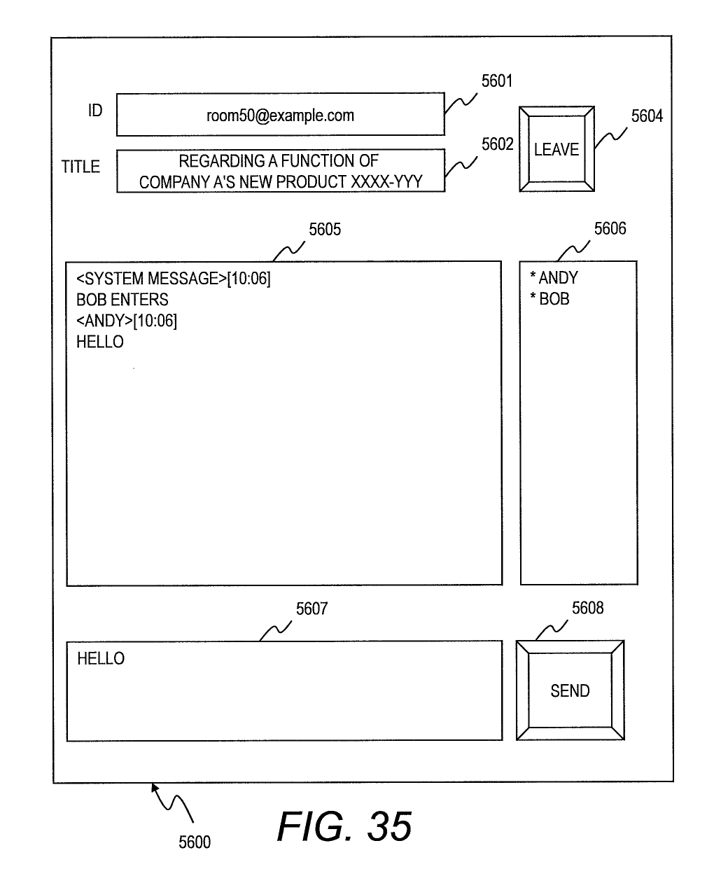

FIG. 35 shows an example of a conversation screen 5600 of the multi-user chat client according to the second embodiment of this invention.

The conversation screen 5600 of the multi-user chat client shown in FIG. 35 includes a display field 5601 for the chat room ID, a display field 5602 for the title of the consultation, a button 5604 for instructing to leave, a message display field 5605, a display field 5606 for users belonging to the chat room, an input field 5607 for a message transmitted from the user himself/herself, and a button 5608 for transmitting the message.

In this embodiment, a date and time to enter the chat room is set as the conversation start time of the user, and a date and time to leave the chat room is set as the conversation finish time of the user. A method of the maintaining the conversation log regarding the conversation start, the conversation finish, and the conversation data is the same as the method performed by the IM server 7 in the first embodiment. Therefore, in this embodiment, description of the method of maintaining the conversation log will be omitted.

In the second embodiment, finally, a procedure for finishing the chat room is performed after the reception of the consultation finish request. First, the consultation management program 232 instructs the conversation place management program 237 to finish the chat room. The conversation place management program 237 transmits a chat room finish request to the management service providing program 933 on the multi-user chat server 9 (S541). The chat room finish request includes the chat room ID of the chat room.

Upon reception of the chat room finish request, the management service providing program 933 finishes the specified chat room through the multi-user chat server program 931, and returns a chat room finish response (S542). At this time, the user who is still participating in the chat room is forced to leave the chat room.

The management service providing program 933 notifies the consultation management program 232 that the chat room has successfully been finished. Having been notified that the chat room has successfully been finished, the consultation management program 232 updates the status of an item of the conversation data including the corresponding chat room ID into “finished” (S543). In addition, the consultation management program 232 updates the membership statuses of all of items of the conversation membership data regarding the corresponding conversation into “leave” (S544).

The above-mentioned steps constitute the procedure for finishing the chat room.

A processing related to the evaluation of the adviser is the same as that of the first embodiment. Therefore, in this embodiment, description of the processing related to the evaluation of the adviser will be omitted.

As described above, in the second embodiment, the one-to-many communication method is used, which makes it possible to simultaneously consult a plurality of advisers. Accordingly, the time period necessary for the solution of the consultation can be made shorter than the first embodiment. Further, by presenting the requester with the expected response time and/or the expected processing time in the whole group of advisers based on an assumption that a plurality of advisers are consulted simultaneously, it is possible to support the requester to estimate the time period taken until the problem is solved.

Further, the consultation intermediate server 2 can automatically transmits the notification of the consultation to a new adviser depending on the status of each consultation. This can automatically invigorate the conversation and reduce the time period taken until the problem is solved.

Further, the consultation intermediate server 2 checks the log of each conversation to thereby prevent the number of advisers from deviating between consultations. This can improve the efficiency of the entire consultation intermediate system.

The embodiments of this invention have been described above in detail by referring to the accompanying drawings, but specific structures and configurations are not limited to those embodiments, and this invention includes designs within the scope that does not depart from the gist of this invention.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a management server for managing communication between user terminals; and
a presence server for managing presence information on users of user terminals which is coupled with the management server,
the user terminals including a first user terminal for originating a question and a second user terminal for responding to the question originated from the first user terminal,
the management server comprising: an interface coupled to the network; a processor coupled to the interface; and a memory coupled to the processor,
wherein the management server is configured to:
calculate an unresponsive time taken until the second user terminal becomes ready to receive a notification of the question transmitted from the first user terminal by referring the presence information acquired from the presence server, upon detection of an origination of the question from the first user terminal;
estimate an expected response time of the second user terminal based on the calculated unresponsive time; and
notify the first user terminal of the estimated expected response time.

2. The computer system according to claim 1, wherein the management server is further configured to:
calculate a response initiation time taken from when the second user terminal receives a notification of a question until the second user terminal starts responding to the question by referring time periods taken from when the second user terminal received some notifications of some questions in a past until the second user terminal started responding the questions; and
estimate the expected response time by adding the calculated unresponsive time and the calculated response initiation time.

3. The computer system according to claim 1, wherein the management server is further configured calculate as the unresponsive time an average value of time periods each taken from a time instant when the second user terminal became unable to receive a notification of a question in a past until a time instant when the second user terminal again became ready to receive the notification of the question by referring the acquired presence information.

4. The computer system according to claim 1, wherein the management server is further configured to:
calculate a probability that the second user terminal responds to the notified question based on a probability that the second user terminal responded to some questions in a past; and
notify the first user terminal of the calculated probability.

5. The computer system according to claim 1, wherein the management server is further configured to:
calculate an expected processing time used by the second user terminal to respond to the notified question based on processing times used by the second user terminal to respond to some questions in a past;
add the calculated expected processing time to the estimated expected response time; and
notify the first user terminal of the expected response time to which the expected processing time is added.

6. The computer system according to claim 5, wherein the management server is further configured to:
select a second user terminal from second user terminals among which a second user terminal unable to respond to the question by the set answering deadline is ranked in a lower place based on a result of comparing an answering deadline of the question set by the first user terminal with the expected response time to which the expected processing time is added; and
notify the first user terminal of a list of the selected second user terminal.

7. The computer system according to claim 6, wherein the management server is further configured to:
calculate a load on the second user terminal based on at least one of a number of questions that have currently been accepted by the second user terminal, a number of questions that were accepted by the second user terminal during a predetermined period, and a number of notifications of a question that were transmitted to the second user terminal during the predetermined period; and
select the second user terminal from the second user terminals among which a second user terminal on which the calculated load is high is ranked in a lower place.

8. The computer system according to claim 6, wherein the management server is further configured to:
obtain information on a response ability of the second user terminal corresponding to a type of the question;
calculate a response ability of the second user terminal with respect to the question transmitted from the first user terminal based on the obtained information on the response ability; and
select the second user terminal from the second user terminals among which a second user terminal with high calculated response ability is ranked in a lower place.

9. The computer system according to claim 6, wherein the management server is further configured to:
obtain information on a response ability of the second user terminal corresponding to a type of the question;
calculate an adequacy of the second user terminal with respect to the question transmitted from the first user terminal based on the obtained information on the response ability; and
select the second user terminal from the second user terminals among which part of the plurality of second user terminals with the calculated adequacies similar to one another are ranked in lower places in case of which a plurality of second user terminals with the calculated adequacies similar to one another can be selected.

10. The computer system according to claim 6, wherein the management server is further configured to:
obtain information on a response ability of the second user terminal corresponding to a type of the question;
calculate an adequacy of the second user terminal with respect to the question transmitted from the first user terminal based on the obtained information on the response ability; and
select, in case of which a plurality of second user terminals with the calculated adequacies similar to one another can be selected, the second user terminal from the second user terminals among which part of the plurality of second user terminals with the calculated adequacies similar to one another are ranked in higher places.

11. The computer system according to claim 6, wherein the management server is further configured to select, in case of which a number of selected second user terminals exceeds a predetermined number, second user terminals for a number equal to or less than the predetermined number.

12. The computer system according to claim 1, wherein the management server is further configured to:
calculate a load on the second user terminal based on at least one of a number of questions that have currently been accepted by the second user terminal, a number of questions that were accepted by the second user terminal during a predetermined period, and a number of notifications of a question that were transmitted to the second user terminal during the predetermined period; and
notify the first user terminal of the calculated load.

13. The computer system according to claim 12, wherein the management server is further configured to:
convert the calculated load into a time period;
add the calculated load to the estimated expected response time; and
notify the first user terminal of the expected response time to which the load is added.

14. The computer system according to claim 1, wherein the management server is further configured to calculate an urgency of the question transmitted from the first user terminal based on an answering deadline of the question set by the first user terminal.

15. The computer system according to claim 12, wherein the management server is further configured to forward the notification of the question transmitted from the first user terminal to the second user terminal with a delay based on the calculated load.

16. A computer system, comprising:
a management server for managing communication between user terminals; and
a presence server for managing presence information on users of user terminals which is coupled with the management server,
the user terminals including a first user terminal for originating a question and a second user terminal for responding to the question originated from the first user terminal,
the management server comprising: an interface coupled to the network; a processor coupled to the interface; and a memory coupled to the processor,
wherein the management server is configured to:
obtain a response initiation time taken until the second user terminal started responding to a question in a past;
calculate a response initiation time taken from when the second user terminal receives some notifications of some questions until the second user terminal starts responding to the questions by referring the obtained response initiation time in the past, upon detection of an origination of the question from the first user terminal;
estimate an expected response time of the second user terminal based on the calculated response initiation time; and
notify the first user terminal of the estimated expected response time.

17. The computer system according to claim 16, wherein the management server is further configured to:
calculate an unresponsive time taken until the second user terminal becomes ready to receive the notification of the question transmitted from the first user terminal by referring the presence information obtained from the presence server; and
estimate the expected response time by adding the calculated unresponsive time and the calculated response initiation time.

18. A communication management server for managing communication between user terminals,
the user terminals including a first user terminal for originating a question and a second user terminal for responding to the question originated from the first user terminal,
the communication management server comprising:
an interface coupled to a network;
a processor coupled to the interface; and
a memory coupled to the processor,
wherein the communication management server is coupled via the network to the user terminals and a presence server for managing presence information on users of the user terminals; and
wherein the communication management server is configured to:
calculate an unresponsive time taken until the second user terminal becomes ready to receive a notification of the question transmitted from the first user terminal by referring the presence information acquired from the presence server, upon detection of an origination of the question from the first user terminal;
estimate an expected response time of the second user terminal based on the calculated unresponsive time; and
notify the first user terminal of the estimated expected response time.

19. The communication management server according to claim 18, wherein the communication management server is further configured to:
calculate a response initiation time taken from when the second user terminal receives a notification of a question until the second user terminal starts responding to the question by referring time periods taken from when the second user terminal received some notifications of some questions in a past until the second user terminal started responding the questions; and
estimate the expected response time by adding the calculated unresponsive time and the calculated response initiation time.
